(19) United States
(12) Patent Application Publication
(10) Pub. No.: US 2003/0065409 A1
(43) Pub. Date: Apr. 3, 2003

(54) Adaptively detecting an event of interest

(76) Inventors: Peter G. Raeth, Beavercreek, OH (US); Randall L. Bostick, Springboro, OH (US); Donald Allen Bertke, Beavercreek, OH (US)

Correspondence Address: SHERIDAN ROSS PC, 1560 BROADWAY, SUITE 1200, DENVER, CO, 80202

(21) Appl. No.: 09/967,022

(22) Filed: Sep. 28, 2001

(51) Int. Cl. G06N 3/08; G06F 15/18; G05B 13/02

(52) U.S. Cl. 700/31; 700/30; 700/44; 700/28

(57) ABSTRACT

A detection system for detecting unusual or unexpected conditions in an environment monitored by one or more sensors generating a data samples for input to the detection system. The detection system includes a predictive signal processor that identifies unexpected data samples output by the sensors. The predictive signal processor includes at least one prediction model M for predicting subsequent data samples of a data stream S input to M from the sensors. M uses past sensor data samples of S that correspond anticipated environmental conditions for iteratively predicting a subsequent likely sensor data sample from S. If there is a sufficient variance between the actual subsequent sensor data of S, and it's corresponding prediction, then a likely event of interest is identified. When the predictive signal processor is not detecting a likely event of interest due to a prediction by M, M iteratively adapts its predictions according to the most recent input data samples. When the predictive signal processor detects a likely event of interest due to a prediction by M, M does not use the data samples received during the detection for determining subsequent predictions. Thus, M processes its stream of data samples differently depending on a variance in its prediction from the corresponding actual data sample.

### RELATED FIELD OF THE INVENTION

The present invention relates to an adaptive system and method for processing signal data, and in particular, for processing signal data from sensors for detecting an event of interest such as an intruder, a visual or acoustic anomaly, a system malfunction, or a contaminant. The present invention also relates to the use of adaptive learning systems (e.g., artificial neural networks) for detecting unexpected events.

### BACKGROUND

A common means employed commercially for anomaly detection is to set a threshold based on deep apriori knowledge of the data stream and the types of anomalies expected. There are two basic approaches for doing this. One approach measures the difference between the current sample and the (simple) moving average of some number of past samples. The other approach checks to see if the current sample value is greater or less than some fixed value. The moving average approach is illustrated in FIG. 1. In FIG. 1 a graph of the chaotic equation xₜ=Cxₜ₋₁(1.0−xₜ₋₁) is shown (which is near but not quite random). In particular, this equation is chaotic when 3.6<=C<4.0 and 0.0<x₀<1.0, where C is a constant, x₀ is the first value of x, xₜ₋₁ is the previous value of x, and xₜ is the newly computed, current, value of x. This equation is illustrated in FIG. 1 for C=3.6 and x₀=0.25. Additionally in FIG. 1, two moving averages shown superimposed on the chaotic graph, one moving average using 3 data sample points, and one using 20 sample points. In such a dynamic environment as presented by the range values of FIG. 1, such moving averages do not work for detecting events of interest such as anomalies with sustained values below the moving average.

Regarding fixed thresholds for detection of events of interest, FIG. 2 shows fixed-value thresholds for the chaotic graph of FIG. 1. Anomalies are presumed to be detected when sample values are greater than, or less than certain values such as thresholds 204 and 208.

The difficulty with either of the above approaches is the heavy use or requirement of apriori knowledge concerning the data stream and characterizations of events of interest to detect. Further, traditional thresholds such as illustrated by the moving average and fixed threshold approaches do not provide an appropriate dynamic range for determining at least one of: the events that are not of interest, and the events that are of interest. That is, they do not adapt readily to evolving data streams such as those driven by complex principle physical properties that have not been sufficiently quantified to provide an analytical predetermined characterization for identifying the events of interest.

Thus, it would be advantageous to have a method and system that could detect events of interest (e.g., anomalies) in a more effective manner than the prior art. In particular, it would be advantageous to have a signal processing method and system that could:

(1.1) adapt with an input data stream for detecting events of interest so that, e.g., the ranges for classifying a data sample as part of an event of interest (or not) dynamically varies in an “intelligent” manner that learns from past data samples what ranges of values are expected (or dually, unexpected);

(1.2) provide the benefits of (1.1) with reduced amounts analysis of the principle physical properties generating data stream values.

### DEFINITION OF TERMS

The definitions terms provided here are to be understood as a more complete description of such terms than may also be described elsewhere herein. Unless otherwise indicated, the definitions here should be considered as applicable to each occurrence of these terms elsewhere herein. Additionally, further background information may be found in the references: “Adaptive Data Mining Applied To Continuous Image Streams”, by Raeth, Bostick, and Bertke, Proceedings: IEEE/ASME Annual Conference on Artificial Neural Networks in Engineering (ANNIE). November 1999, and “Finding Events Automatically In Continuously Sampled Data Streams Via Anomaly Detection”, by Raeth and Bertke, IEEE National Aerospace & Electronics Conference (NAECON). October 2000, both of these references being fully incorporated herein by reference.

Monitored environment: This is any environment having one or more sensors for supplying data samples indicative of one or more characteristics of the environment. For example, the monitored environment may be: (a) an exterior area having thermal and/or spectral sensors thereabout for detecting the presence of animated objects other than small animals, (b) a communications network having sensors thereattached for detecting network bottlenecks and/or incomplete communications, (c) a terrestrial area monitored by a satellite having optical and/or radar sensors for detecting “unusual” airborne objects, (d) a patient having medical sensors attached thereto for obtaining data related to the patient's health, etc.

Event of interest: This is any situation or circumstance occurring in a monitored environment, wherein is desirable to at least detect the situation or circumstance that is occurring or has occurred. The event of interest may be, e.g., any one of: an anomaly within the environment, an unexpected situation or circumstance, a change in the environment that occurs more rapidly than anticipated changes, etc.

Sensor(s): This term denotes sensing element(s) that detect characteristics of the environment being monitored. The signal processing method and system of the present invention detects events of interest in the environment via output from such sensor(s). In particular, this output (or derivatives thereof) is typically denoted as samples, data samples, and/or data sample information as described in the definitions below.

Prediction Model(s): The signal processing method and system of the present invention includes a plurality of substantially independent computational modules (e.g., prediction models 46 (FIG. 3) as described hereinbelow), wherein each prediction model receives a series of data samples from one of the sensors, and upon receiving each such input data sample, the prediction model outputs a prediction of some future (e.g., next) data sample. In one embodiment, such prediction models 46 may be considered as anomaly detection models, wherein data samples provide an indication of a relatively persistent and unexpected event in the monitored environment.

This term further refers to one or more embodiments of an evolving mathematical process that estimates and/or predicts data samples from a data stream. In one embodiment, the mathematical process may be an artificial neural network (ANN) that uses a set of Gaussian radial basis functions and statistical calculations. The parameter values within the ANNs, for each of the embodiments, evolve from training data input thereto for developing effective predictions of next samples in the data stream.

Data sample (information): As used herein these terms denote data obtained from sensors that monitor the environment. Note that in some embodiments of the invention this data may be pre-processed, e.g., transformed, or filtered, prior to being input to the prediction models.

Prediction Error (P_{E}): For a corresponding prediction model, the prediction error is the difference between: (a) a prediction of a data sample S, and (b) the actual corresponding data sample S; e.g.,

Prediction error=Actual−Predicted=P_{E}

Local Prediction Error: For a corresponding prediction model, the “local” prediction error is the prediction error P_{E} for the most recent data sample input to a corresponding prediction model.

Average Prediction Error: For a corresponding prediction model M, the “average” prediction error is a number of prediction errors P_{E} averaged together. Typically, such an average is for a predetermined consecutive number of recent prediction errors for prediction model M.

Range Relative Prediction Error (R_{PE}): For a corresponding prediction model M and a particular prediction error P_{E} for M, the relative prediction error is the ratio of P_{E} to the maximum range of values obtained from data samples of a window W of consecutive (possibly filtered) data samples delivered to M; i.e.,

$$( Relative {P}_{E} ) = {R}_{PE} = \frac{{P}_{E}}{MAX - MIN}$$

where MAX and MIN are the largest and smallest values of the data samples in the window W of data samples.

The relative prediction error is used to better relate the prediction error to the actual data sample range. For instance, a prediction error, P_{E}, equal to 20 is not meaningful until the actual data range is known. If this range is 20,000 then 20 is trivial. If this range is 2 then 20 is huge. These issues are discussed by Masters, T. (1993). Practical Neural Network Recipes in C++. New York, N.Y.: Academic Press, pp 64-66 which is incorporated by reference herein.

Mean Relative Prediction Error (M_{RPE}): For a corresponding prediction model M and for a sequence of relative prediction errors R_{PE(i)} for M, the mean relative prediction error is the average of the relative prediction errors of the sequence;

$$\text{i.e.} , ( Mean {R}_{PE} ) = {M}_{RPE} = \frac{{\sum }_{i = 1}^{N} {R}_{PE ( i )}}{N}$$

Average Range—Relative Prediction Error (ARRPE): For a corresponding prediction model M and for a sequence of mean relative prediction errors M_{RPE(i)} for M, the average range-relative prediction error is the average of a consecutive series R_{PE} values obtained for data samples of a window W of consecutive (possibly filtered) data samples delivered to M; i.e.,

ARRPE=AVERAGE {R_{PE} for the data samples in a corresponding window W of data samples} for a predetermined number of consecutive of such R_{PE} values, each next R_{PE} obtained, from a corresponding next moving window W of data samples.

Machine: As used herein the term “machine” denotes a computer or a computational device upon which a software embodiment of at least a portion of the invention is performed. Note that the invention may be distributed over a plurality of machines, wherein each machine may perform a different aspect of the computations for the invention. Optionally, the term “machine” may refer to such devices as digital signal processors (DSP), field-programmable gate arrays (FPGA), application-specific integrated circuits (ASIC), systolic arrays, or other programmable devices. Massively parallel supercomputers are also included within the meaning of the term “machine” as used herein.

Host: As used herein the term “host” denotes a machine upon which a supervisor or controller for controlling the operation of the invention resides.

Radial Basis Functions: Basis functions are simple-equation building blocks that are a proven means of modeling more complex functions. Brown (in the book by Light, W., (ed). (1992). Advances in Numerical Analysis, Volume II. Oxford, England:

Claredon Press. p203-206 showed that if D is a compact subset of the k-dimensional region R^{k}, then every continuous real-valued function on D can be uniformly approximated by linear combinations of radial basis functions with centers in D. Proofs of this type have also been shown by: (i) Funahashi (1989). On the Approximate Realization of Continuous Mappings by Neural Networks. Neural Networks, vol 2, (e.g., pp 183-192); Girosi, F., Poggio, T. (October 1989). Networks and the Best Approximation Property. Massachusetts Institute of Technology Artificial Intelligence Laboratory, Memo # 1164; and (iii) Hornik, K. Stinchcombe, M., White, H. (1989). Multilayer Feedforward Networks are Universal Approximators. Neural Networks, vol 2, (e.g., pp 359-366)all of these references being fully incorporated herein by reference.

Any function that is used to generate a more complex function may be said to be a basis function of the more complex function. The graphs produced by these more complex functions can be interpreted in such a way that they can be useful for classification, interpolation, prediction, control, and regression, to name a few applications. The application may also determine the shape of the basis functions used. The value of the individual basis functions is determined at one or more points in the domain space to arrive at the value(s) of the more complex function.

As an elementary example of a radial basis function, consider a circle. The equation of a circle centered at Cartesian coordinates (x_{c}, y_{c}) has the equation (x−x_{c})²+(y−y_{c})²=r². Where r is the radius of the circle. For a given x between (x_{c}±r) inclusive (non-existent elsewhere), this equation becomes y=y_{c}±\sqrt{r²−(x−x_{c})²} so that it is possible to completely describe the circle via a function defined on the appropriate range of x for the given descriptive factors r, x_{c}, and y_{c}. The circle is “radial” because of the factor r as measured from the center, (x_{c}, y_{c}); i.e., the graph of the equation exists at the same distance r from the center in all directions within the Cartesian plane.

The basis function used to build the prediction model of the present invention is the following Gaussian function:

y=e^{-πσ}^{ᵢ}^{²}^{∥x-ξ}^{ᵢ}^{∥}^{²} (Equation RB)

wherein

∥x−ξᵢ∥²=(x−ξᵢ)

σᵢ² is the variance at node i (Gaussian width)

ξᵢ is the center or location of Gaussian basis function i in region Rⁿ

x is the location in R¹ of a given input vector.

The above basis function is somewhat more complex than a circle, but the use thereof as a basis function is similar. Moreover, this basis function is radial and has the following additional advantages:

(i) described by a continuous function,

(ii) exists everywhere, and

(iii) theoretically has infinite support (is non-zero everywhere).

It is possible to extend the above equation to more than one dimension (See Sanner, R. M. (1993). Stable Adaptive Control. PhD Dissertation, Massachusetts Institute of Technology, Doc # AAI10573240., fully incorporated herein by reference), but at least in some embodiments of the present invention, such multi-dimensional basis functions are not required. However, if such multi-dimensional basis functions are used in an embodiment of the invention, then it is possible to use a different variance for each dimension. Thus, the basis function becomes non-radial. In such a general case, the exponent in the basis function equation immediately above becomes:

−π{σᵢ₁²(x₁−ξᵢ₁)²+σᵢ₂²(x₂−ξᵢ₂)²+ . . . +σᵢₙ²(xₙ−ξᵢₙ)²}

Note that the corresponding basis function is radial when all σᵢₓ are equal so that the variance of the resulting in all dimensions is the same.

A Gaussian function is said to be “centered” at the point where it reaches its largest value. This occurs at the point where x=ξᵢ in the Gaussian function of Equation RB above, as one skilled in the art will understand. Also, the value of the radial Gaussian is the same for all x equi-distant from the center (ξᵢ).

Note that the height of each Gaussian radial basis function according to Equation RB is normally fixed at one. However, it is an aspect of the present invention that a prediction model for the invention adjusts the height of each basis function individually such that the composite function is the result of a pointwise summation of two or more Gaussian functions so that the total summation is the expected next value in the data sequence.

For more detailed descriptions of radial basis functions and their utility, the following references are provided and fully incorporated herein by reference:

a. Funahashi, K. (1989). On the Approximate Realization of Continuous Mappings by Neural Networks. Neural Networks, vol 2, pp 183-192.

b. Girosi, F., Poggio, T. (October 1989). Networks and the Best Approximation Property. Massachusetts Institute of Technology Artificial Intelligence Laboratory, Memo # 1164.

c. Hornik, K. Stinchcombe, M., White, H. (1989). Multilayer Feedforward Networks are Universal Approximators. Neural Networks, vol 2, pp 359-366.

d. Light, W., (ed). (1992). Advances in Numerical Analysis, Volume II. Oxford, England: Claredon Press.

e. Sanner, R. M. (1993). Stable Adaptive Control. PhD Dissertation, Massachusetts Institute of Technology, Doc # AAI0573240.

f. Sundararajan, N., Saratchandran, P., Ying Wei, L. (1999). Radial basis function neural networks with sequential learning. River Edge, N.J.: World Scientific.

g. Van Yee, P., Haykin, S. (2001). Regularized radial basis function networks: theory and applications. New York, N.Y.: John Wiley.

ST: For a given prediction model M that is not currently providing predictions indicative of M detecting a likely event of interest, the term ST denotes a threshold for determining whether a prediction error measurement (for M), e.g., a relative prediction error, is within an expected range that is not indicative of a likely event of interest, or alternatively is outside of the expected range and thus may be indicative of an event of interest (e.g., given that there is a sufficiently long series of prediction error measurements that are outside of their corresponding expected ranges). The expected range is on one side of ST while prediction error measurements on the other side of ST are considered outside of the expected range. In one embodiment, prediction error measurements <=ST are within an expected range, and those greater than ST are considered outside of the expected range.

For a given prediction error measurement, PEM, the value of ST with which PEM is compared is determined as a function of previous prediction error measurements for M, and more particularly, previous prediction error measurements that have not been indicative of a likely event of interest. Thus, when, e.g., a series of outputs from M results in M detecting a likely event of interest, then during the continued detection of this likely event of interest, ST does not change.

In some embodiments, ST is a function of a standard deviation, STDDEV, of a window of moving averages, wherein each of the averages is the average of a predetermined number of consecutive prediction error measurements such that each of the prediction error measurements is not indicative of a detection of a likely event of interest. For example, ST may be in the range of 0.9* STDDEV and 1.1* STDDEV.

RtNST: For a given prediction model M, that is currently providing predictions indicative of M detecting a likely event of interest, the term RtNST denotes a threshold for determining whether a prediction error measurement (for M), e.g., a relative prediction error, is within an expected range that is not indicative of a likely event of interest, or alternatively is outside of the expected range and thus is indicative of a continuation of the detection of the likely event of interest. The expected range is on one side of RtNST while prediction error measurements on the other side of RtNST are considered outside of the expected range. In one embodiment, prediction error measurements <=RtNST are within an expected range, and those greater than RtNST are considered outside of the expected range.

For a given prediction error measurement, PEM, the value of RtNST with which PEM is compared is determined as a function of previous prediction error measurements for M, and more particularly, previous prediction error measurements that have not been indicative of a likely event of interest. Thus, when, e.g., a series of outputs from M results in M detecting a likely event of interest, then during the continued detection of this likely event of interest, RtNST does not change.

In most embodiments of the invention, RtNST is less than or equal to ST. For example, RtNST may be in the range of 0.6*ST to 0.85*ST. In some embodiments, RtNST is a function of a standard deviation, STDDEV, of a window of moving averages, wherein each of the averages is the average of a predetermined number of consecutive prediction error measurements such that each of the prediction error measurements is not indicative of a detection of a likely event of interest.

DT: For a given prediction model M that is not currently providing predictions indicative of M detecting a likely event of interest, the term DT denotes a threshold for determining whether there is a sufficient number of prior recent prediction error measurements (for M), e.g., relative prediction errors, that are outside of the expected range, for their corresponding ST, that is not indicative of a likely event of interest.

Note that the prior recent prediction error measurements may be consecutively generated for M. However, it is within the scope of the invention that the prior recent error measurements may be “almost consecutive” as defined in the Summary section below.

RtNDT: For a given prediction model M that is currently providing predictions indicative of M detecting a likely event of interest, the term RtNDT denotes a threshold for determining whether there is a sufficient number of prior recent prediction error measurements (for M), e.g., relative prediction errors, that are within the expected range, for their corresponding RtNST, that is not indicative of a likely event of interest.

Note that the prior recent prediction error measurements may be consecutively generated for M. However, it is within the scope of the invention that the prior recent error measurements may be “almost consecutive” as defined in the Summary section below.

### SUMMARY

The present invention is a signal processing method and system for at least detecting events of interest. In particular, the present invention includes one or more prediction models for predicting values related to future data samples of corresponding input data streams (e.g., one per model) for detecting events of interest.

Moreover in one aspect of the present invention, discrepancies between such prediction values and subsequent actual corresponding data stream sample values are used to determine whether a likely event of interest is detected. Furthermore, it is an aspect of the present invention that such prediction models are adaptive to the environment that is being sensed so that, e.g., such models are able to adapt to data samples indicative of relatively slowly changing features of the background and also adapt to data samples indicative of expected (e.g., repeatable) events that occur in the environment. In particular, such prediction models may be statistical and/or trainable, wherein historical data samples may be used to calibrate or train the prediction models to the environment being monitored. More particularly, such a prediction model may be:

(2.1) an artificial neural network (ANN) having radial basis functions as evaluation functions at the neurons. Alternatively, other types of ANNs are also contemplated by the present invention such as: a neural gas ANN, a recurrent ANN, a time delay ANN, a recursive ANN, and a temporal back propagation ANN;

(2.2) a statistical model such as: a regression model, a cross correlation model, an orthogonal decomposition model, a multivariate splines model;

(2.3) a generalized genetic programming module, a linear and/or nonlinear programming model, or an inductive reasoning model.

Additionally, it is an aspect of the present invention that an environmental dependent criteria is provided for identifying whether such a discrepancy (between prediction values and subsequent corresponding actual data stream sample values) is indicative of a likely event of interest. In at least some embodiments of the invention, this criteria includes a first collection of thresholds, wherein:

(a) there is one such threshold per prediction model,

(b) each such threshold is indicative of a boundary between values related to data samples not representative of an event of interest, and alternatively, data samples representative of environmental events of likely interest,

(c) when such a threshold is crossed from the side of the threshold for events of no interest to the side indicative of events of likely interest, an event of likely interest is detected.

For indicating that a likely event of interest has occurred, such a threshold (also denoted ST herein) may be compared to a difference between a data sample prediction and its corresponding subsequent actual value (e.g., the difference being a prediction error). However, other comparisons and/or techniques are within the scope of the invention for indicating the commencement of a likely event of interest. For example, combining some number of sequential beyond-threshold prediction errors and comparing the resulting combination with an evolving threshold. Another example is correlating prediction errors with some event occurring elsewhere at the same time or within some bounded time period surrounding the set of prediction errors that lead to the postulation that an event has started.

Additionally note that the thresholds of this first collection of thresholds may vary with recent fluctuations in the samples of the data streams obtained from the sensors. In one embodiment of the invention, such a threshold (e.g., for a prediction model M₁) may be determined according to a variance in the data samples input to M₁, wherein the variance may be, e.g.:

(3.1) a function of a standard deviation of a plurality of recent data samples input to M₁; e.g., the recent data samples may be: (i) from a recent window of all data samples, and (ii) not indicative of a likely event of interest having occurred;

(3.2) a function of the widest range in recent data samples input to M₁. In particular, the recent data samples may be, e.g., from a recent window of all data samples, and not indicative of a likely event of interest having occurred. Moreover, such recent data samples may be exclusive of outliers that are not indicative of an event of interest;

(3.3) Same as in (3.1) and (3.2) but for data sample prediction errors rather than the data samples themselves. If the prediction error is historically large, then a still larger error is needed to pass the threshold. The threshold is the difference between what has historically occurred and what is presently occurring.

It is a further aspect of the present invention that an additional environmental dependent second criteria is provided for identifying when a likely event of interest has ceased to be detected by a prediction model. Moreover, in at least some embodiments of the invention, this second criteria is also a second collection of thresholds, wherein

(a) there is one such threshold per prediction model,

(b) each such threshold is also indicative of a boundary between data samples representative of environmental events of presumed no interest, and data samples representative of environmental events of likely interest,

(c) when such a threshold is crossed from the side of the threshold indicative of an event of likely interest to the side indicative of events of no interest, the event of likely interest is identified as terminated. For indicating that a likely event of interest has terminated, such a threshold (also denoted RtNST herein) may be compared to a difference between a data sample prediction and its corresponding subsequent actual value (e.g., the difference being a prediction error). However, other comparisons and/or techniques are within the scope of the invention for indicating the termination of a likely event of interest. Accordingly, the thresholds of this second criteria may also vary with recent fluctuations in the samples of the data streams obtained from the sensors. In at least one embodiment of the invention, such a threshold (e.g., for a prediction model M₂) may be determined according to a variance in the data samples input to M₂, wherein the variance may be dependent on conditions substantially similar to (3.1) through (3.3) above.

Moreover, it is an aspect of the invention that for at least some embodiments, at least one of the predictive models has a corresponding first threshold from the first collection and a second threshold from the second collection. Furthermore, the second threshold may be on the side of the first threshold that is indicative of no event of interest. Thus, once a likely event of interest is detected, the corresponding predictive model does not return to a state indicative of no event of interest occurring by merely crossing the first threshold in the opposite direction. Instead, a further amount in the direction away from the event of interest side of the first threshold may need to be reached; i.e., the second threshold.

In addition to the thresholds above, embodiments of the invention may also include one or more “duration thresholds”, wherein there may be two such duration thresholds for a prediction model (e.g., M₃), wherein:

(4.1) a first of the duration thresholds for M₃ is indicative of the number of predictions by M₃ whose corresponding prediction errors are on the side of the first threshold ST indicative of a likely event of interest being detected. Note that this first threshold may vary with a moving average of some number of past consecutive relative prediction errors. In particular, the threshold ST may be a fixed percentage of the standard deviation of the moving averages of a window of past relative prediction errors. Accordingly, these consecutive relative prediction errors, in one embodiment, correspond to consecutive data samples provided to M₃. However, it is within the scope of the invention that such prediction errors for this first duration threshold (also denoted as DT herein) need not be necessarily consecutive. For example, a likely event of interest may be declared whenever a particular percentage of the recent prediction errors for M₃ are indicative of a likely event of interest being detected; e.g., 90 out of the most recent 100 prediction errors wherein at least the earliest 10 prediction errors of the 100 and the 10 latest prediction errors of the window of 100 prediction errors are indicative of a likely event of interest being detected. Note that the term “almost consecutive” will be used herein to refer to a series of prediction errors (generally, the series being of a predetermined length such as 100) wherein some small portion of the prediction errors do not satisfy a criteria for declaring a change in state related to whether a likely event of interest has commenced or terminated. For example, this “small portion” may be in the range of zero to 10% of the prediction errors in the series;

(4.2) a second of the duration thresholds for M₃ is indicative of the number of prediction errors for M₃ on the side of the second threshold RtNST that must occur for a likely event of interest to be identified as terminated. However as with the first duration threshold, it is within the scope of the invention that such prediction errors for this second duration threshold (also denoted RtNDT herein) need not be necessarily consecutive; i.e., they may be almost consecutive.

It is also an aspect of the present invention that for some embodiments there are a relatively large plurality of the prediction models, wherein each such model is able to predict an event of interest substantially independently of other such models. Moreover, such independent models may have different input data streams from the sensors monitoring the environment. For example, if the data streams are output by one or more imaging sensors, then each model may receive a data stream corresponding to a different portion of the images produced by the sensors. In particular, there may be a different data stream for each pixel element of the sensors, although data streams from other image portions (e.g., groups of pixels) are also contemplated by the invention. Accordingly, there may be a very large number of prediction models (e.g., on the order of thousands) included in an embodiment of the invention. Additionally, note that such a large number of prediction models may also occur in non-image related applications, e.g., applications such as audio, communications, gas analysis, weather, environmental monitoring, facility security, perimeter defense, treaty monitoring, and other applications where sensors provide a time-sequential data stream. Additionally, in combination with such applications, there may be event logs from computer system security middleware or machine monitoring equipment as one skilled in the art will understand. Moreover, in such applications there can be a large plurality of different data streams available from various types of sensor arrays that are capable of sensing various wavelengths in the frequency spectrum. Such sensor arrays may include, but are not limited to, multi-, hyper-, and ultra-spectral sensor arrays, sonar grids, motion detectors, synthetic aperture radar, and video/audio security matrices, wherein each of (or at least some of) these different data streams can be supplied to a different (and unique) prediction model.

Additionally, note that it is also within the scope of the invention to supply at least some common data streams to a plurality of prediction models. For example, several models may be set up to monitor the same data stream but each model would have a different set of thresholds and/or number of basis functions.

Since the prediction models may be substantially (if not completely) independent of one another in detecting a likely event of interest, the present invention lends itself straightforwardly to implementation on computational devices having parallel/distributed processing architectures (or simulations thereof). Thus, it has been found to be computationally efficient to distribute the prediction models over a plurality of processors and/or networked computers. However, since the prediction models may be relatively small (e.g., incorporating less than 30 basis functions), it may be preferred not to have the processing for any one model split between processors. Rather, each processor should, in such a case, process more than one prediction model.

In addition to the parallel processing implementations of the present invention, the processing for the invention may be distributed over the computational nodes of a network to thereby provide greater parallelism in detecting an event of interest. Accordingly, a host machine may initially receive all data streams, subsequently distribute the date streams to other nodes in the network, and then collect the results from these nodes for determining whether an event of interest has been detected. Moreover, note that in one embodiment of the invention, there is included functionality for adjusting how such a distribution occurs depending on the topology of the network and the computational characteristics of the network nodes (e.g., how many processors each node has available to use for the present invention).

It is also important to understand that the present invention is not just a temporal filter as those skilled in the art understand the term. In particular, such a filter typically is substantially only useful on data streams manifesting particular signal processing characteristics for which the filter was designed. However, a substantially same embodiment of the present invention can be effectively used on quite different signal data. Accordingly, embodiments of the invention can be substantially spectra independent and domain knowledge independent in that relatively little (if any) domain or application knowledge is needed about the generation of the data streams from which events of interests are to be detected. This versatility is primarily due to the fact that the prediction models included in the present invention are trained and/or adaptive using sequences of data samples indicative of events in the environment being monitored, and more particularly, trained to predict “uninteresting” background and/or expected events. Thus, an “interesting event” is presumed to occur whenever, e.g., a sufficient number of predictions and their corresponding actual data sample are substantially different.

To further emphasize the domain or application independence of the present invention, note that, the sequences of input data samples need not necessarily be representative of a time series. For example, such data samples may be representative of signals in a frequency domain rather than a time domain. Additionally, note that the present invention makes no assumptions about the regularity or periodicity of the sample data. Thus, in one embodiment, the sample data input streams may received from “intelligent” sensors that are event driven in that they provide output only when certain environmental conditions are sensed.

Moreover, the data samples may represent substantially any environmental characteristic for which the sensors can provide event distinguishing information. In particular, the data samples may include measurements of a signal amplitude, a signal phase, the timing of portions of a signal, the spectral content of a signal, time, space, etc.

In an imaging application, the present invention may support sub-pixel detection of events of interest. For example, the present invention may detect an instance of an anomaly in an image field as soon as the difference between the predicted value and the corresponding actual value is outside of the range of a relative prediction error of the “uninteresting” background events in the environment. Thus, sub-pixel detection of anomalies in images is supported since a small but abrupt unexpected change in a pixel's output may trigger an occurrence of an event of interest. In particular, the present invention may be more sensitive to abrupt deviations from predictable changes (and/or slower changes) to a background environment than, e.g., traditional filters that do not dynamically adapt with such slow or predictable changes in the environment.

In a geometric shape detection application, the present invention can provide detection of events of interest as well as indications of their shape. For example, assuming that there is a data stream per sensor pixel and that it is known how the pixels for these data streams are arranged relative to one another, then the collection of prediction models (one per pixel) that detect an event of interest concurrently can be used to determine a shape of an object causing the events of interest. For example, by providing knowledge of the relative orientation of the pixels providing data streams from which events of interest are detected, a shape matching process may be used to identify the object(s) being detected. Furthermore, if such an object moves within the field of sensor view, then its trajectory, velocity and/or acceleration may be estimated as well.

In some applications instead determining a shape of an unexpected object in a sensor's field of view, the present invention may be used to provide an indication as to the size of the object. For example, in such applications, it can be the case that actual events of interest require concurrent detection of events of interest by the prediction models whose corresponding pixels are substantially clustered together, and additionally, the cluster must be at least of some minimal size to be of sufficient interest for further processing to be performed. For instance, applications where such pixel cluster sizes can be used are: (i) intrusion detection, (ii) detection of weather formations, (ii) range and forest fire detection, (iv) missile or aircraft launch detection, (v) explosion detection, (vi) detection of a gas or chemical release; and/or (vii) detection of abnormal crop, climatic, or environmental events.

In other embodiments of the present invention, the sensitivity for detection of events of interest can be set depending on the requirements of the application in which the invention is applied. In particular, it has been discovered by the applicants that to detect an event of interest (e.g., an anomaly) early during its occurrence, the threshold ST can be set in a range of 0.85 to 1.15 of a standard deviation above the mean relative error and then trigger an indication of a likely event of interest every time the threshold ST is exceeded. Similarly, a likely event of interest is terminated when the mean relative error falls below the threshold ST (i.e., RtNST=ST in this case). However, it is also an aspect of the present invention to balance the identifying of early detections of likely events of interest with the generation of an excessive number of false alarms. Accordingly, embodiments of the present invention can include additional components for further refining the likeliness that an event of interest has occurred and/or better identifying such an event of interest. For example, such additional components may be:

(5.1) target tracking and/or identification components that commence tracking and/or identification once a likely event of interest (e.g., an aircraft or missile) is detected. Note that it is believed that the present invention can provide greater resolution and sensitivity when integrated into an existing detection system so that target detection can be improved, and in particular, improved in noisy environments where the signals are: sonar, high-speed communications signals, and satellite sensors; and/or sensor systems with low signal-to-noise ratios.

(5.2) low resolution sensing capabilities such as barometric pressure, temperature, motion alarms, frame-subtraction filters, and linear filters.

Other aspects and benefits of the present invention will become apparent from the accompanying drawings and the Detailed Description hereinbelow.

### BRIEF DESCRIPTION OF THE DRAWINGS

FIG. 1 shows graphs of two moving averages for outputs of the equation xₜ=Cxₜ₋₁(1.0−xₜ₋₁) also graphed hereon. The equation is chaotic when 3.6<=C<4.0 and 0.0<x₀<1.0, where C is a constant, x₀ is the first value of x, xₜ₋₁ is the previous value of x, and xₜ is the newly computed, current, value of x. This equation is illustrated in FIG. 1 for C=3.6 and x₀=0.25. One of the moving averages shown in this figure uses 3 data consecutive sample points to compute each moving average value. The other moving average shown in this figure uses 20 data consecutive sample points to compute each moving average value.

FIG. 2 shows examples of fixed-value thresholds for the chaotic graph of FIG. 1. Anomalies are detected when sample values are greater than threshold 204, or less than threshold 208, or in between thresholds 204a and 208a.

FIG. 3 shows a block diagram of the high level components for a number of embodiments of the present invention. It should be understood that not all components illustrated in FIG. 3 need be provided in every embodiment of the invention.

FIG. 4 shows three corresponding pairs of instances of the adaptive thresholds ST (404a, b, c) and RtNST (408a, b, c), as defined in the Definition of Terms section. hereinabove, for the chaotic data sample stream of FIG. 1.

FIG. 5 illustrates a high level flowchart of the steps performed by the prediction analysis modules 54 of the prediction engine 50 when these modules transition between the non-detection state, the preliminary detection state, and the detection state.

FIG. 6 is a flowchart that provides further detail regarding detecting the beginning and end of a likely event of interest, wherein the likely event of interest is considered to be an anomaly.

FIG. 7 shows the local and mean prediction error obtained from inputting the data stream of FIG. 1 into a prediction model 46 for the present invention (i.e., the prediction model being an ANN having radial basis adaptation functions in its neurons).

FIG. 8 shows a plot of the standard deviation of a window of the prediction errors when the data stream of FIG. 1 is input to an artificial neural network prediction model.

FIG. 9 provides an embodiment of a flowchart of the high level steps performed for initially training the prediction models 46.

FIGS. 10A and 10B provide a flowchart showing the high level steps performed by the present invention for detecting a likely event of interest.

FIG. 11 illustrates a flowchart of the steps performed for configuring an embodiment of the invention for any one of various hardware architectures and then detecting likely events of interest. In particular, FIG. 11 illustrates the steps performed in the context of processing data streams obtained from pixel elements.

FIG. 12 is a top-level view of the classes that implement the parallel architecture (and the steps of FIG. 11).

FIG. 13 shows how various hardware implementations bring expanded throughput, complexity, and cost, along with the need for greater computer engineering skill to implement the invention.

### DETAILED DESCRIPTION

The signal processor of the present invention identifies events of interest by receiving, e.g., a time-series of data samples from sensors monitoring a designated environment for events of interest. Thus, since the present invention has a wide range of different embodiments and applications, the descriptions of embodiments and applications of the invention hereinbelow are illustrative only and should not to be considered exhaustive of the invention.

Block Diagram Description

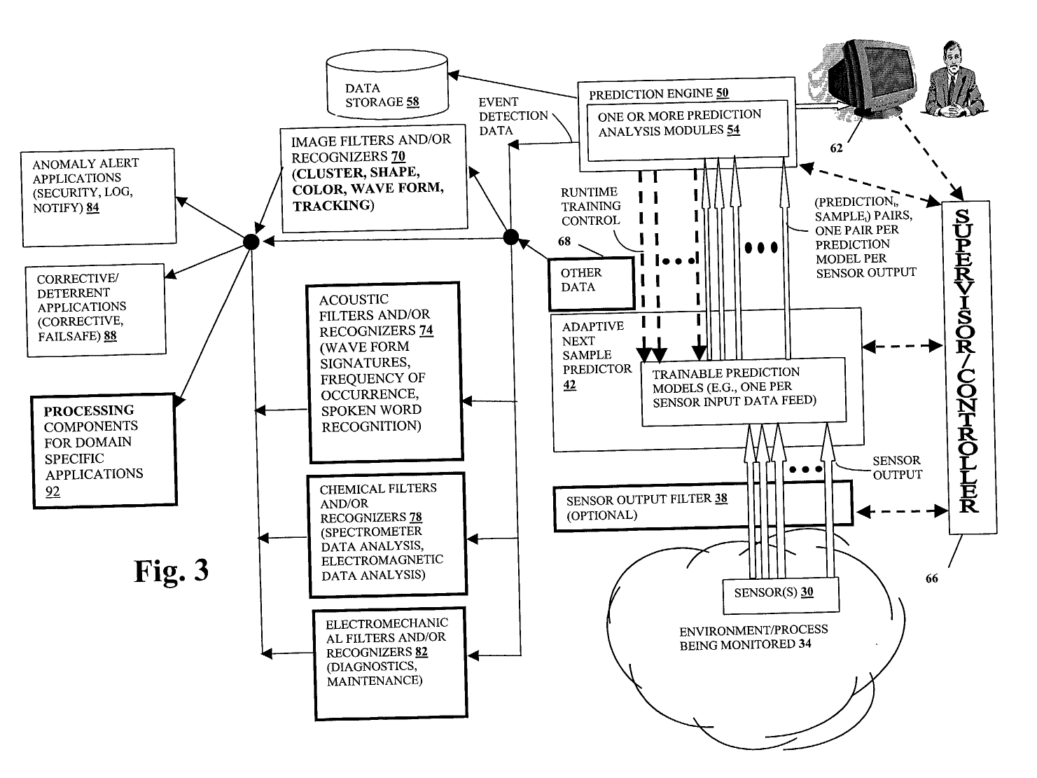

FIG. 3 shows a block diagram of the high level components for a number of embodiments of the present invention. Accordingly, it should be understood that not all components illustrated in FIG. 3 need be provided in every embodiment of the invention. In particular, the components that are dependent on the output from the prediction engine 50 (described hereinbelow) may depend on the application specific functionality desired.

Referring now to the components shown in FIG. 3, the sensors 30 are used to monitor characteristics of the environment 34. These sensors 30 output at least one (and typically a plurality of) data stream(s), wherein the data streams (also denoted as sensor output data 44) may each be, e.g., a time series. The data streams 44 are supplied to either the sensor output filter 38, or the adaptive next sample predictor 42 depending on the embodiment of the invention. If provided, the sensor output filter 38 filters the data samples of the data streams 44 so that, e.g., (a) the noise therein may be reduced, (b) the data samples from various data streams 44 may be coalesced to yield a derived data stream, (c) the data streams from, e.g., malfunctioning sensors, may be excluded from further processing, and/or (d) particular predetermined criteria may be selected from the data streams (e.g., high frequency acoustics). Either directly or via the sensor output filter 38, data streams 44 are provided to the adaptive next sample predictor 42, wherein for each data stream 44 input to the adaptive next sample predictor, there is at least one corresponding prediction model 46 that is provided with the data samples from the data stream. Thus, the adaptive next sample predictor 42 coordinates the distribution of the data stream data samples to the appropriate corresponding prediction models 46.

When supplied with data samples, each of the prediction models 46 outputs a prediction of an expected future (e.g., next) data sample. To accomplish this, each of the prediction models 46 is sufficiently trained to predict the non-interesting background features of the environment 34 so that a deviation by an actual data sample from its corresponding prediction by a sufficient magnitude is indicative of a likely event of interest. In particular, each of the prediction models 46 is substantially continuously trained on recent data samples of its input data stream 44 so that the prediction model is able to provide predictions that reflect recent expected changes and/or slow changes in the environment 34. However, note that the prediction models 46 are not trained on data samples that have been determined to be indicative of a likely event of interest (as will be discussed further below). Thus, each prediction model 46 can be in one of three following states depending on the prediction model's training and the classification of the data samples of its input data stream:

(6.1) an untrained state, wherein the prediction model is not deemed to be trained sufficiently to appropriately predict the background or uninteresting events of the environment 34. Accordingly, the predictions output by the prediction model may not be used to identify likely events of interest. Note that in this state, the data stream input to the prediction model should be indicative of an environment having no likely events of interest occurring therein;

(6.2) a normal state, wherein the prediction model 46 is deemed sufficiently trained so that its output predictions can be used in detecting likely events of interest. Thus, each new data sample may be used (when no likely event of interest has been detected): (a) to determine a new prediction, and (b) to further train the prediction model 46 so that its predictions reflect the most recent sensed environmental characteristics. Note that this state is likely to be the state that most prediction models 46 are in most of the time once each has been sufficiently trained;

(6.3) a suspended state, wherein the prediction model 46 does not output a prediction that is based on the input data samples in the same manner as in the normal state, and importantly, does not use such data samples for further training. This state is entered when it is determined that the data samples include information indicative of detecting a likely event of interest. In this state a prediction model 46, in response to each new data sample received, outputs a prediction that is dependent upon one or more of the last predictions made when in the prediction model 46 was most recently in the normal state. For example, an output prediction in this state might be the last prediction from when the model was most recently in the normal state. Alternatively, an output prediction in this state might be an average of a window of the most recent predictions in the normal state.

Note that the prediction models 46 may be artificial neural networks (ANNs), or adaptive statistical models such as regression, cross-correlation, orthogonal decomposition, multivariate spline models. Of particular utility are ANN prediction models 46 that output values that are summations of radial basis functions, and in particular Gaussian radial basis functions (such functions being described in the Definition of Terms section above). Moreover, in at least some embodiments, it is preferable that such prediction models 46 be trained without using an ANN back propagation technique (such techniques known to those skilled in the art). Note that a discussion on the training and maintenance of the prediction models 46 is provided hereinbelow.

As mentioned in the SUMMARY section hereinabove, an embodiment of the present invention may have a very large number of prediction models 46. In particular, when image data is output by the sensors 30, there may be a prediction model 46 per each pixel of the sensors 30. Accordingly, tens of thousands of prediction models 46 may be provided by the adaptive next sample predictor 42.

For each of the prediction models 46, M, and for each prediction P generated thereby, P is output to the prediction engine 50, wherein a determination is made as to whether a subsequent actual data sample(s) corresponding to the prediction P is sufficiently different from P to warrant declaring that a likely event of interest has been detected in a data stream 44 being input to M. The prediction engine 50 includes one or more prediction analysis modules 54 that identify when a likely event of interest is detected, and when a likely event of interest has terminated. Of particular importance is the fact that the prediction analysis modules 54 are data-driven in the sense that these modules use recent fluctuations or variances in one or more of the data samples to M and/or variances related to the prediction errors for M to determine the criteria for both detecting and subsequently terminating likely events of interest. For example, these modules determine the thresholds ST and RtNST (as discussed in the SUMMARY section above). Moreover, when determining the thresholds ST and RtNST for a given data stream, such determinations are dependent upon a variance, such as a fixed portion of a standard deviation, STDDEV, of a collection or sequence of recent values related to the actual data samples from a corresponding one of the data streams 44 providing input to M. For example, such recent values may be:

(a) A series of simple moving averages <aᵢ>, wherein each average aᵢ is the average of a sequence of relative prediction errors in a window of recent relative prediction errors that were computed for prior data samples input to M. For example, the window of recent relative prediction errors may be for 100 consecutive data samples, and the series <aᵢ> may include the most recent 50 such averages aᵢ. Note that a weighted moving average of several factors is calculated as

$$\frac{{\sum }_{i = 1}^{n} {W}_{i} {X}_{i}}{{\sum }_{i = 1}^{n} {W}_{i}} \text{where:}$$

i refers to an given factor,

n is the number of factors (size of the averaging window),

Wᵢ is the weight applied to a given factor,

Xᵢ is the factor referenced by i.

In a “simple” moving average all the Wᵢ are the same value such that Wᵢ can be ignored in the calculation.

(b) A weighted (non-simple) moving average, wherein weights are applied that, e.g., decrease as a sample's time distance from the current sample increases.

Thus, ST may be given a value in the range of, e.g., [0.8*STDEV, 1.2*STDEV], and more preferably (in at least some embodiments) [0.9*STDEV, 1.1*STDEV].

Accordingly, it is an aspect of the present invention that when there is a greater amount of variance in the non-interesting features of the environment 34, appropriate detection of likely events of interest can be performed. That is, the invention can dynamically adapt to a greater (or lesser) discrepancy between predictions and their corresponding actual data samples and still detect a high percentage of the likely events of interest without proliferating false positives. Additionally, it is within the scope of the present invention that the prediction analysis modules 54 may also vary duration thresholds DT and RtNDT (these thresholds are also discussed in the SUMMARY section above). That is, recent fluctuations or variances in data samples and/or prediction errors may be used for determining, e.g., the number of consecutive (or almost consecutive as described in the SUMMARY section) prediction errors that must reside on a particular side of a duration threshold for the prediction analysis modules 54 to declare that a likely event of interest has commenced or terminated. For example, the DT threshold may be directly related to the RPE standard deviation and the RtNDT threshold can be inversely related to the RPE standard deviation.

Additionally, note that when the prediction analysis modules 54 determine that a likely event of interest is detected by one of the prediction models M, the prediction analysis modules send a control message to M requesting that the prediction model 46 enter the suspended state. Similarly, when the prediction analysis modules 54 determines that a likely event of interest is no longer detected in a particular data stream 44, then the prediction analysis modules send a control message to the corresponding prediction model receiving the data stream as input, wherein the message requests that this prediction model 46 re-enter the normal state.

Further note that the prediction engine 50 may provide substantially all of its input (e.g., data samples and predictions), and subsequent results (e.g., detections and terminations of likely events of interest) to the data storage 58 so that such information can be archived for additional analysis if desired. Moreover, this same information may also be supplied to an output device 62 having a graphical user interface for viewing by a user.

The present invention also includes a supervisor/controller 66 for controlling the signal processing performed by the various components shown in FIG. 3. In particular, the supervisor/controller 66 configures and monitors the communications between the components 38, 42, 46, 50 and 54 described hereinabove. For example, the supervisor/controller 66 may be used by a user to configure the distribution of the prediction models 46 over a plurality of processors within a single machine, and/or configure the distribution of the prediction models over a plurality of different machines that are nodes of a communications network (e.g., a local area network or TCP/IP network such as the Internet). Additionally, since at least some embodiments of the invention have the prediction engine 50 functionality performed by a designated machine, the supervisor/controller 66 is used to setup the communications between the processors/network nodes performing the prediction models 46 and the processor/network node performing prediction analysis modules 54. Note that the supervisor/controller 66 may, in some embodiments, dynamically change the configuration of the computational elements upon which various components (e.g., prediction models 46) of the present invention perform their tasks. Such changes in configuration may be related to the computational load that the various computational elements experience.

In at least one embodiment of the present invention, the supervisor/controller 66 communicates with and configures communications between other components of the invention via an established international industrial standard protocol for inter-computer message passing such as the protocol known as the Message-Passing Interface (MPI). This protocol is widely-accepted as a standardized way for passing messages between machines in, e.g., a network of heterogeneous machines. In particular, a public domain implementation of MPI for the WINDOWS NT operating system by MicroSoft Corp. may be obtained from the Aachen University of Technology, Center for Scalable Computing by contacting Karsten Scholtyssik, Lehrstuhl für Betriebssysteme (LfBS) RWTH Aachen, Kopernikusstr. 16, D-52056, or by contacting the website having the following URL: http://www.lfbs.rwth-aachen.de/˜karsten/projects/nt-mpich/index.html. Applicants have found MPI to be acceptable in providing communications between various distributed components for embodiment of the present invention.

Although not shown in FIG. 3, it is worth noting that the supervisor/controller 66 may also monitor, control, and/or facilitate communications with additional components provided in various embodiments of the invention such as the below described filters 70 through 82, as well as further downstream application specific processing modules indicated by the components 84 through 92.

Regarding the filters 70 through 82, these filters are representative of further processing that may be performed to verify that indeed an event of interest has occurred, and/or to further identify such an event of interest. Such filters 70 through 82 receive event detection data output by the prediction engine 50, wherein this output at least indicates that a likely event of interest has been detected (by each of one or more prediction models 46 whose identification is likely also provided). Additionally, such filters 70 through 82 also receive input from the filter 50 when a likely event of interest ceases to be detected (by some prediction model 46 whose identification is likely also provided). In fact, such filters may receive one or more messages that substantially simultaneously indicate that the data stream to a first prediction model is no longer providing data samples indicative of a likely event of interest, but the data stream for a second prediction model 46 now includes data samples indicative of a likely event of interest. Moreover, such filters may also receive: (a) the data streams 44 (or data indicative thereof) from, e.g., the sensors 30, as well as (b) other environmental input data (denoted other data sources 68 in FIG. 3) which can, e.g., be used to provide substantially independent verification of the occurrence of an event of interest.

The filters 70 through 82 may be further described as follows:

(7.1) The image filters 70. Such a filter may be an intensity/phase anomaly filter, wherein normal image pixel intensity digital values are provided as input to the filter. The filter output is a binary indication that the intensity of the input has exceeded a predetermined statistical variance from a intensity background prediction. This filter works with any imaging or non-imaging sensor that collects temporal intensity values.;

(7.2) The acoustic filters 74. Such a filter may be an intensity/phase anomaly filter, wherein normal acoustic intensity digital values are provided as input to the filter. The filter output is a binary indication that the intensity of the input has exceeded the predetermined statistical variance from the intensity background prediction. This filter works with any imaging or non-imaging acoustic sensor that collects temporal intensity values. Example, a machine monitoring sensor that measures the sounds from a machine. This filter will detect when the sounds change, potentially indicating that the machine is experiencing a failure, such a bearing failing. This filter detects such subtle changes long before a conventional technique senses a change in the machine operating noise.;

(7.3) The chemical filters 78. Such a filter may be an intensity/phase anomaly filter, wherein normal acoustic intensity digital values are provided as input to the filter. The filter output is a binary indication that the intensity of the input has exceeded the predetermined statistical variance from the intensity background prediction. This filter works with any chemical material detection sensor that collects temporal intensity values. Example, a chlorine monitoring device could indicate when the concentration of chlorine gas changed in a pool, indicating that the supply of chemical needs to be replenished.;

(7.4) The electromechanical filters 82. Such a filter may be an intensity anomaly filter, wherein normal electromechanical detection intensity digital values are provided an input to the filter. The filter output is a binary indication that the intensity of the input has exceeded the predefined statistical variance from the intensity background prediction. This filter works with any electromechanical sensor that collects temporal intensity values; and/or

(7.5) A spatial filter (not shown). A simple output from such a filter is a binary map that may be used in conjunction with other filtering devices. In one embodiment, a spatial filter receives image or focal plane data and a binary mask is output indicating where possible events of interest occur as determined by the filter. It is then up to a user to apply the mask to the data and determine if there are pixels that correspond to an event of interest. In another embodiment, such a spatial filter may be used in clutter suppression. If the filter is predicting the pixel values for the next frame, then this predicted next frame can be subtracted from the actual next pixel frame. In this case a processed pixel frame where all pixels are ideally very close to zero, except in the case where possible event of interest may be represented. Accordingly, secondary tests such as adjacency (most sensors are designed such that energy is distributed in a Gaussian manner) or temporal endurance (a pixel lighting up in only one frame is an unlikely events of interest) can be used to determine if the processed pixel values exceeding a predetermined threshold are indicative of a likely events of interest. If the processed pixel values are indicative of a likely events of interest, then the data in those pixels is not used to update the state of the spatial filter. Such a spatial filter may be used in a display tool which displays the processed pixel frames and the real pixel intensities after clutter suppression.

It is likely that not all types of such filters 70 through 82 would be used in a given embodiment of the invention. Accordingly, such filters may be selectively provided and/or selectively activated by, e.g., the supervisor/controller 66 depending on user input and/or depending on the type of signal data being processed. Thus, the filters 70 through 82 may be viewed in some sense as an intermediate level between the substantially application independent front-end components 42 through 66, and the substantially application specific components 84 through 92. For example, the filters 70 through 82 may utilize knowledge specific to processing a particular type of signal data such as spectral image signals, or acoustic signals, etc. However, such filters may not access application specific information such as who to notify and/or how to present an event of interest when it occurs. Additionally, such filters may not need to know the environment from which the data streams are derived; e.g., whether the data streams are image data from satellites or from an imaging sensor on a tree.

Regarding the components 84 through 92, these components are merely representative of the application specific components that can be provided in various embodiments of the present invention. Note that the components 84 through 92 may receive input from one or more instances of the filters 70 through 82, or altemately/additionally, may receive input directly from the prediction engine 50 (such input may be substantially the same as the input to the filters 70 through 82, or such input may be different, e.g., a message to alert a technician of a possible anomaly). The components 84 through 92 and their corresponding applications may be described as follows:

(8.1) Anomaly alert components 84 and their applications. Components of this type are intended to deal with totally unexpected environmental changes. It is often the case that environments 34 may include a complex system of inter-related factors, wherein such a system may not manifest faults until an unanticipated event occurs. Such manifested faults can cause system failures that can present themselves in a multitude of ways. The anomaly alert components 84 and (any) corresponding applications, e.g., for determining the source of a system failure, can be used to alert one or more responsible persons and/or activate one or more electronic anomaly diagnosis/rectification components.

Such anomaly alert components 84 and corresponding (if any) applications may be used for monitoring an environment 34 for, e.g., intruders, inclement weather, fires, missile launches, unusual gas clouds, abnormal sounds, explosions, or other unanticipated events. In particular, the components 84 may included hardware and software for:

(8.1.1) Logging likely events of interest. Accordingly, the component here include at least an archival database (not shown) for logging likely events of interest that have subsequently been determined as actual events of interest. Moreover, in some applications (e.g., where detection and subsequent processing of likely events of interest must be performed remotely without manual intervention and in substantially real time such as some space based applications), specialized data transmission components may also be required such as: dedicated transmission lines such as T1, T2, or T3; microwave, optical, or satellite communications systems;

(8.1.2) Security components, such as: encryption/decryption capability; automated system controllers, control panels for human operation; cameras; microphones; sensors of various types; specialized lighting; signal and data recorders; human or robotic response teams;

(8.1.3) Notification components, such as: sirens, horns, audio or visual alarms, displays of various types, automated communications possibly including a pre-recorded message; indicators of various types.

(8.2) Corrective/deterrent components 88 and their applications. These components react to the various interesting events by attempting to return the environment 34 to a state where there are no interesting events occurring. For instance, one such corrective/deterrent component 88 might be a crisp or fuzzy expert system that determines an appropriate action to perform due to, e.g., an abnormal temperature, such a temperature being outside of an expected temperature range. Sensors 30 for an abnormal temperature detection and correction embodiment of the present invention may, for example, operate in the infrared range or may include a mercury switch mechanically coupled to an object in the environment 34. The input to such corrective/deterrent components 88 may be an out-of-norm indicator provided by the prediction engine 50 and the raw sensor 30 values during the time the out of range temperature is detected. Components 88 may also receive input from other sources or analyzed in light of other information for determining what (if any) action is to be performed. For instance, for a device having a rotating component (measured in revolutions per minute), an abnormal temperature detected by the prediction engine 50 may be of no consequence if the actual temperature value is low and the component's revolutions per minute (RPM) is approaching zero. It could well be normal for the temperature to be directly related to RPM. However, a detected abnormal temperature may be important if the actual temperature is high and the device's RPM has reached to an unreasonably high level. In such cases, absolute limits may apply. Thus, non-varying thresholds may be used, in combination with the components 42, 50 and 56, for providing further detection of interesting events. By extension, the components 42, 50 and 56 might be used in combination with other systems such as rule based systems for making more absolute detections. Accordingly, by combining various detection techniques, the resulting system becomes more fail-safe.

Similarly, such corrective/deterrent components 88 can be used to further analyze likely events of interest for, e.g., scheduled occurrences of events that would otherwise be identified as events of interest. For example, if such a component 88 has advance knowledge of a scheduled occurrence of an event (such as a person, vehicle or aircraft traveling through a restricted terrain, a missile launch, or an uncharacteristic radiation signal signature), then when a likely event of interest is detected at the scheduled occurrence time having the signal characteristics of the scheduled event, the component 88 may log the event but not alert further systems or personnel unless the event of interest becomes in some manner uncharacteristic of the scheduled event.

(8.3) Domain specific components 92 for specific applications. In one embodiment, it may be necessary to continually monitor a specific event, such as a change in a gas mixture. For example, a given gas sample should contain a given maximum percentage of oxygen or some other constituent of the gas. Thus, a mass spectrometer may be one such component 92, wherein this component is used to determine such percentages. In another embodiment, if an ambient audio signal should contain a certain dominant radio frequency, then a change in the dominant frequency may trigger an event of interest. Accordingly, the components 92 may include: microphones, cameras, sensors of various types, computers and other data processing equipment, gas analyzers, data acquisition and storage, detectors and sensors of various types, signal processing equipment.

Event of Interest Thresholds:

There are four event of interest thresholds utilized by the present invention in determining whether values, V, based on a difference between predicted and actual data samples, are indicative of a likely event of interest being represented in a corresponding data stream. These thresholds are described generally in the Definition of Terms section prior to the Summary section. However, in one embodiment of the invention, these thresholds can be described as follows:

(9.1) A likely event of interest sample threshold (ST): This threshold provides a value above which the differences between predicted and actual values provide an indication that a likely event of interest may exist.

(9.2) A return to normal sample threshold (RtNST): This threshold provides a value below which the differences between predicted and actual values provide an indication that an event of interest is no longer likely to exist.

(9.3) An event of interest duration threshold (DT): This threshold provides a number which is indicative of the number of sequential values V above ST that must occur before hypothesizing that a likely event of interest exists.

(9.4) A return to normal duration threshold (RtNDT): This threshold provides a number which is indicative of the number of sequential values V below RtNST that must occur before determining that an event of interest is no longer likely to exist.

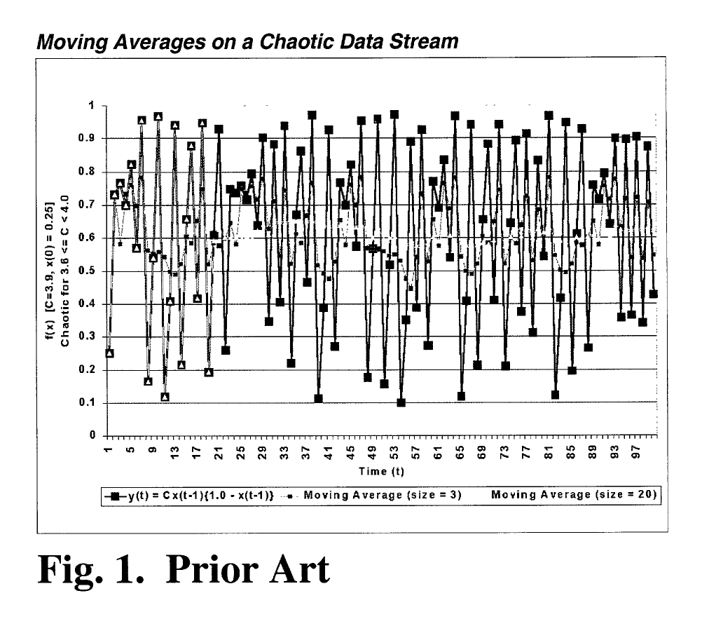

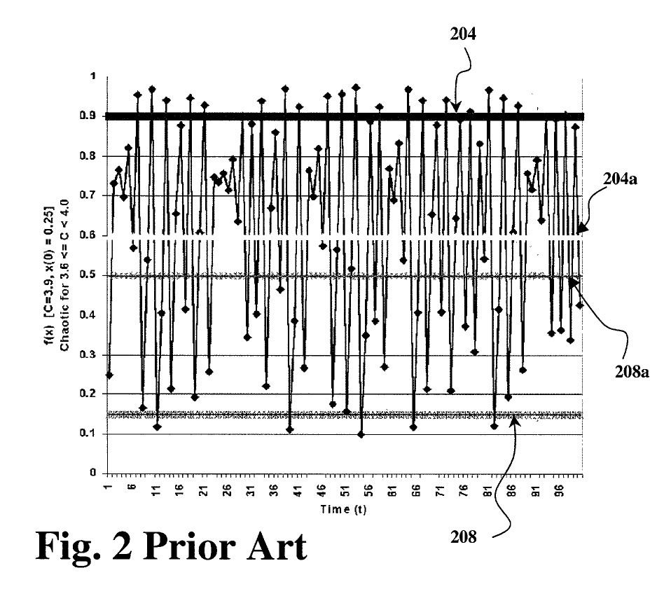

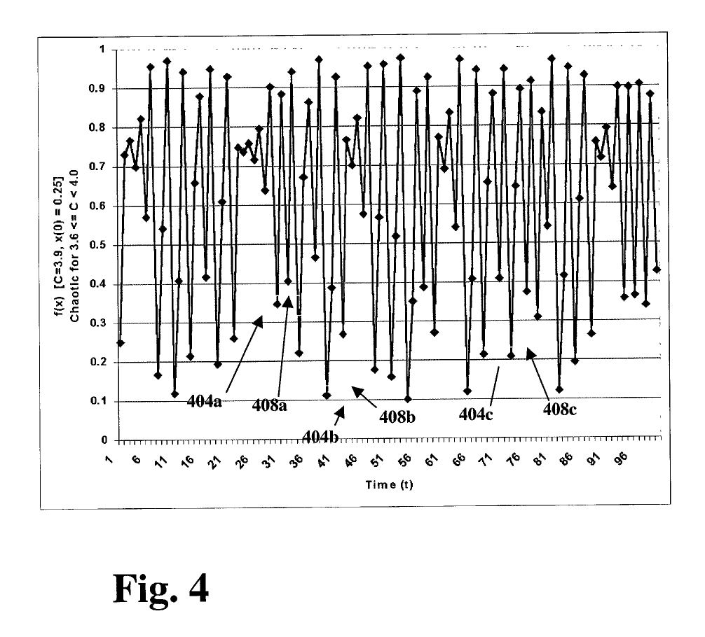

FIG. 4 shows three corresponding pairs of instances of ST (404a, b, c) and RtNST (408a, b, c) threshold values for the chaotic data sample stream of FIG. 1.

Note that there are substantially equivalent alternative threshold definitions that are within the scope of the invention. In particular, embodiments of the present invention may be provided wherein ST is replaced with ST₁ which is a threshold value below which corresponding values indicative of likely events of interest are identified, as one skilled in the art will understand. For example, a simple mathematical transformation such as multiplication by −1 of both ST and prediction errors is well within the scope of the present invention. For a more sustentative example, it may be the case that one or more a sensors 30 output data 44 that is truly random whenever there is no likely events of interest occurring. Accordingly, the corresponding prediction models 46 for such output data 44 may never reach an effective level of performance to predict the next sample with any reasonable reliability and accuracy. Thus, when such prediction models consistently achieve a relative prediction error below ST₁, this may be indicative of a likely event of interest. Additionally, termination of such a likely event of interest may occur when the signal returns to a random sequence.

Detection of a likely event of interest can be taken from two points of view. If the sampled signal is such that a relatively low prediction error can be achieved, then the detector should be set to postulate likely events of interest when the prediction error is consistently ABOVE some threshold, and to postulate the end of the likely event of interest when the prediction error falls BELOW some other threshold. Alternatively, if it is not possible to achieve a low prediction error, then a likely event of interest may be postulated when the prediction error consistently falls BELOW some threshold, while the end of such a likely event of interest may be postulated when the prediction error is ABOVE some other threshold. In the first case, predictability is the norm. In the second case, predictability is indicative of a likely event of interest. Note that both points of view can be the basis for embodiments of the present invention.

Similarly, it is within the scope of the invention that RtNST may, in some embodiments, be replaced with RTNST₁, which is a threshold value above which corresponding values are indicative of likely events of interest no longer existing. Note, however, for simplicity in all subsequent descriptions hereinbelow that the thresholds ST and RtNST, as well as DT and RtNDT, will be used with the understanding that their meanings are intended to be as in (9.1) through (9.4) above, but this is not to be considered a limitation of the scope of the invention. Additionally, note that since there may be a collection of the thresholds ST, DT, RtNST and RtNDT for each prediction model 46, and in some contexts hereinbelow these thresholds are indexed or otherwise identified with their corresponding prediction model 46.

In general, each of the thresholds ST, DT, RtNST and RtNDT is set according to domain-particular parameters dependent upon the likely events of interest (e.g., targets, intruders, aircraft, missiles, vehicles, contaminants, etc.) to be detected. Such parameters may include, but are not limited to, parameters indicative of:

(a) an expectation as to the randomness of data samples. A test of randomness in the data samples can help determine the configuration of a prediction model so that it either detects predictable or non-predictable signals. If the underlying signal is random then the signal will not be predictable. Therefore, the model should be set up to detect (as likely events of interest) signals falling below the established prediction error threshold. Conversely, if the underlying signal is not random then the signal will be predictable and the model should be set up to detect (as likely events of interest) signals that are above the established prediction error threshold. Such tests for randomness come from standard statistics and are something a knowledgeable practitioner would be familiar with. Note that two standard tests of randomness are autocorrelation and z-scores obtained from run tests. Non-random signals have positive autocorrelation. They also have z-scores with absolute value greater than 1.96. In both cases only lag-1 calculations are required for this application since in general only the very next sample is predicted. References on such topics are: (i) Filliben, J.J. (Mar. 22, 2000). Exploratory Data Analysis. Chapter 1 in Engineering Statistics Handbook, National Institute of Standards and Technology, (URL:

http://www.it1.nist.gov/div898/handbook/eda/section3/eda35d.htm), (ii) a definition of z-score can be found in: Hoffman, R. D. (January 2000). The Internet Glossary of Statistical Terms, Animated Software Company, (URL:http://www. animatedsoftware.com/statglos/sgzscore.htm), (iii) a discussion on autocorrelation can be found in: Mosier, C. T. (2001). Autocorrelation Tests. course notes, School of Business, Clarkson University, (URL: http://phoenix.som.clarkson.edu/˜cmosier/ simulation/Random_Numbers/Testing/Autocorrelation/auto_test.html,

(b) a signal-to-noise ratio,

(c) an amplitude range and/or duration of non-event of interest outliers,

(d) a size or duration of likely events of interest, and/or

(e) a variability of prediction error.

(f) the frequency content of the data in the FFT sense.

(g) the expected range of the data.

Moreover, certain criteria have been found useful in various application domains for setting such thresholds. These criteria include:

(a) The expected signal to noise range within which event of interest detection is desired;

(b) The application tolerance for false alarms (e.g., an application for identifying a slow moving watercraft may be very tolerant of false alarms whereas an application for detecting a likely oncoming torpedo may be very intolerant of false alarms).

Accordingly, it may be preferable to perform a domain analysis to determine ranges for (or otherwise quantify) these criteria.

In particular, for setting such thresholds satisfactorily, it is desirable that one or more of the following conditions are met:

(a) A history of successfully detecting the start and end of likely events of interest is achieved;

(b) A history of discarding outliers that are not true anomalies;

(c) A history of accurately predicting the next sample in the data stream;

(d) A history of meeting application objectives.

Further, note that the setting of the four thresholds ST, DT RtNST and RtNDT is related to the desired sensitivity of an embodiment of the present invention. For example, as the sensitivity increases (e.g., ST and/or DT is decreased) the number of false positives (i.e., uninteresting events being identified as likely events of interest) is likely to increase. Accordingly, as the number of false positives increases, the actual events of interest detected may become obscured. On the other hand, setting such thresholds to decrease sensitivity may lead to a greater number of actual events of interest going undetected. Moreover, in at least some embodiments, the present invention assumes that event of interest detection sensitivity is related to a measurement of a variance in prediction errors (e.g., a variance in relative prediction errors). In particular, the number of standard deviations of the relative prediction error of the most recently obtained data sample from a mean relative prediction error may be directly related to sensitivity in detecting events of interest. More specifically, in many (if not most application domains), it is believed that events of interest (e.g., anomalies), that are distinguishable from environmental background, are events wherein each data sample received from such an event is likely to have a corresponding relative prediction error that is approximately one standard deviation or more from the mean relative prediction error obtained from some specified number of data samples immediately prior to the detection of the event. Moreover, it is within the scope of the invention for prediction errors to be used to detect likely events of interest using one or more of the following (a) through (e):

(a) A comparison of the current sample's RPE to that of the simple moving average RPE of some number of past samples.

(b) A comparison of the current sample's RPE to that of the weighted moving average RPE of some number of past samples.

(c) A comparison of the current sample's RPE to that of the most recent sample.

(d) A comparison of the current sample's RPE to some predefined absolute threshold.

(e) An RPE moving average (simple or weighted) that includes the current sample compared to an RPE moving average (simple or weighted) base on a window taken just prior to the window that includes the current sample.

Additionally, note that in detecting a likely event of interest, it is important that temporary data outliers caused by, e.g., noise spikes do not trigger an excessive number of false event of interest detections (i.e., false positives). Thus, the value DT is intended to be adjustable so that the proportion of false positives can be thereby adjusted to be acceptable to the signal processing application to which the present invention is applied. Additionally, DT is preferably set in conjunction with the setting of ST. Accordingly, there is typically flexibility in determining either ST or DT in that the other threshold can be adjusted to compensate therefor. For example. a high value for ST (indicative of a low sensitivity) may be compensated by a low DT value so that a smaller number of relative prediction errors are required to rise above the ST threshold.

Relatedly, the return to a normal or non-event of interest detecting state by a prediction model 46 is determined by the corresponding thresholds RtNST and RtNDT. In particular, the RtNST relates the “return to normal” sensitivity to a variance in prediction errors (e.g., relative prediction errors). For example, the RtNST may be a measurement related to a standard deviation of prior relative prediction errors from a mean value of these prior relative prediction errors. More specifically, in many (if not most application domains), it is believed that for a prediction model M to return to the normal (or a non-event of interest) state, the data samples received by M from the monitored environment 34 should result in a series of differences between the corresponding relative prediction errors and a mean relative prediction error being less than the ST, and more particularly, the threshold RtNST should be in a range of, e.g., 0.6*ST to 0.85*ST for at least some specified number of almost consecutive samples or duration identified by RtNDT. So, if the ST is set at one standard deviation, the RtNST may be set to, e.g., 0.75 of this standard deviation.

In yet another related sensitivity aspect for the present invention, the four thresholds ST, RtNST, DT and RtNDT are also used in maintaining the effectiveness of the prediction models 46 so that even after the detection of a large number of likely events of interest, the models are to able to remain appropriately sensitive to likely events of interest and at the same time appropriately evolve with non-event of interest (e.g., more slowly changing and/or expected changes to) characteristics of the environment being monitored. In particular, during the detection of a likely event of interest by one or more of the models, these models are prohibited from using their input data samples that results in, or is received during, the detection of a likely event of interest for further evolving and adapting. Thus, the prediction models 46 are only trained on input data that is presumed to not represent any event of interest.

Additionally, since each such prediction model 46 is not trained on event of interest input data, and since the output prediction values are to detect likely events of interest, during the detection of a likely event of interest, the output from the prediction model is changed to provide values indicative of a non-event of interest environment. More particularly, each prediction model 46, immediately after its data stream is identified as providing data samples that are “interesting”, enters the suspended state wherein for the duration of the likely event of interest, instead of the prediction model outputting a prediction of the next data sample, the prediction model outputs a value indicative of the immediately previous non-event of interest normal state. In particular, a prediction model may output, as its prediction, the last data sample provided to the prediction model prior to the likely event of interest being detected, or alternatively, the model's prediction(s) may be a function of a window of such prior data samples; e.g., an average or mean thereof. Thus, in a suspended state, the prediction model 46 outputs: (a) as a prediction, a value of what a non-event of interest is likely to be according to one or more last known “uninteresting” data samples from the environment 34 being monitored, and (b) the corresponding relative prediction error variation measurements (e.g., measurements relative to a standard deviation) for this last known one or more non-event of interest data samples, wherein these variation measurements may be used for, e.g., determining ST and RtNST while the prediction model is in the suspended state. Moreover, note that it is within the scope of the present invention that other values indicative of prior non-events of interest may also be output by the prediction models 46 when any one of them is in its corresponding suspended state. In particular, other such prediction values and corresponding prediction error variation measurements that may be output by alternative embodiments of a prediction model in the suspended state are:

(a) an average of prior data samples, and an average standard deviation over a window of data input samples immediately prior to the event of interest; or

(b) the output of some alternative model of the portions of the output data 44 that is not indicative of a likely event of interest. An alternative model of this type approximates the output data 44 using additional known characteristics of the output data 44. For example, such a model may operationalize a control law that the output data 44 substantially follows due to the type of sensors 30 and/or the application for which the present invention is used. Thus, such alternative models incorporate additional application knowledge.

Accordingly, when the data input to a prediction model 46 is determined to no longer represent a likely event of interest (e.g., the input data is below RtNST for at least RtNDT almost consecutive data samples), then an end to the likely event of interest (for this prediction model) is determined, and the prediction model is returned to its normal state, wherein it once again predicts the next input data sample and also recommences adapting to the presumed non-event of interest input data samples.

Note that the criteria for determining when to return to a normal state is equally as important as determining when a likely event of interest is occurring in that if a prediction model 46 continues to track a likely event of interest that has fallen below the RtNST threshold, then the prediction model is not being updated with the potentially evolving environmental background. Accordingly, the prediction model 46 will not train on changed but uninteresting background data. Thus, when the prediction model 46 does eventually return to the normal state, the resulting relative prediction errors may be higher than desired, thereby making the prediction model less effective at predicting subsequent data samples. However, if the prediction model 46 returns to its prediction state before a likely event of interest is fully terminated, then the prediction model begins updating its parameters with sample data that likely includes non-background or “interesting” data samples, thereby reducing the prediction model's ability to subsequently detect a further instance of a similar likely event of interest because the data signature of the original likely event of interest may have been incorporated into the adaptive portions of the prediction model.

Moreover, note that as with the ST and DT thresholds, there is a direct relationship between the RtNST and RtNDT thresholds. For example, to compensate for the RtNST being set high (i.e., below but relatively close to ST), RtNDT may be set to be indicative of a relatively long number of data samples being below RtNST.

Additionally it is within the scope of the invention that any one or more of the four thresholds (or correspondingly similar thresholds) may be determined by an alternative process that is, e.g., stochastic and/or fuzzy. For instance, a statistical process for determining, categorizing and/or measuring the “randomness” of input data samples (e.g., over a recent window of such data samples) such that variation in noise in the data sample stream can be used to adjust one or more of the thresholds ST, RtNST, DT, and/or RtNDT. For example, as noise increases (decreases), one or more of the following may increase (decrease): |ST−RtNST|, DT and/or RtNDT. Moreover, such thresholds may be periodically adjusted according to, e.g.: (a) the number of false positives detected in a recent collection of data input samples, and/or (b) the number of likely events of interest that went undetected (i.e., false negatives) in a recent collection of data input samples (wherein such false negatives were detected by an alternative technique).

Additionally, in some embodiments, the thresholds may be adjusted manually by, e.g., “radio dials” on an operator display.

Steps Performed Using the Thresholds

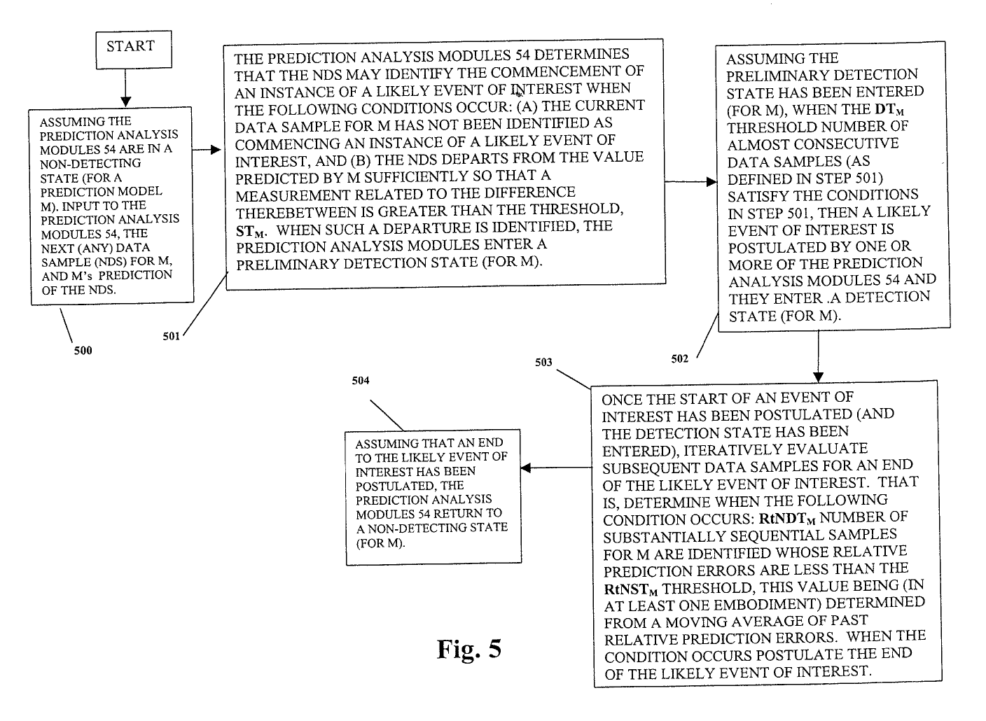

The prediction engine 50 can postulate the existence of a likely event of interest when given a prediction of a next data sample and the actual next data sample. FIG. 5 illustrates a high level flowchart of the steps performed by the prediction analysis modules 54 of the prediction engine 50 when these modules transition between various states. In particular, for each prediction model 46, M(I), the prediction analysis modules 54 are in one of the following states:

(a) A non-detection state, wherein no likely event of interest is currently being detected in a data stream input to the prediction model M(I); e.g., the recent relative prediction errors do not rise above ST for M(I) (denoted ST(I) herein).

(b) A preliminary detection state, wherein no likely event of interest is currently being detected, but M(I) is outputting predictions that are indicative of either one or more transient outliers, or the commencement of a likely event of interest; e.g., for a given input data stream S, a variance between at least the most recent data sample from S for M(I), and the corresponding most recent prediction from M(I) is above ST(I), but no likely event of interest (corresponding to M(I)) is currently being monitored by the prediction analysis modules 54.

(c) A detection state wherein a likely event of interest is currently being detected in a data stream input to the prediction model M(I); e.g., there have been DT(I) (i.e., DT for M(I)) almost consecutive variances between a series of recent data samples for M(I), and their corresponding predictions by M(I) (e.g., relative prediction errors) such that the almost consecutive variances are above ST(I).

Thus, FIG. 5 shows the sequence of steps performed by the prediction analysis modules 54 in transitioning from a non-detection state (for a particular prediction model 46, M) to the preliminary detection state for this particular prediction model, and subsequently to the detection state for this particular prediction model, and finally returning to the non-detection state. The steps of FIG. 5 are described as follows.

Step 500: Assuming that, for a given prediction model 46 (M), the prediction analysis modules 54 are in a non-detection state, input M's prediction for the next data sample (NDS), together with NDS to the prediction analysis modules 54.

Step 501: The prediction analysis modules 54 determine that the NDS may identify the commencement of an instance of a likely event of interest when the following conditions occur:

(A) the current data sample for M (i.e., the most recent data sample for M) has not yet been identified as commencing an instance of a likely event of interest, and

(B) the NDS departs from the value predicted by M sufficiently so that a measurement related to the difference therebetween is greater than the threshold ST.

Accordingly, the prediction analysis modules 54 determine if the conditions of (A) and (B) above are satisfied, and if so, then the preliminary detection state (for predictions from M) is entered. More precisely, for the condition (B), the prediction analysis modules 54 may determine if this condition is satisfied by computing a measurement related to a difference between the NDS and its corresponding predicted value and then determining whether this difference is greater than the threshold ST_{M} (i.e., ST for M). Note that the term “data sample” in this step refers to data that may be the result of certain data stream transformations and/or filters (e.g., via the sensor output filter 38, FIG. 1) that preprocess the sensor sample data prior to inputting corresponding resulting sample data to the prediction model M. Further note that the data samples here may be indicative of signal amplitude, frequency content, power spectrum and other signal measurements.

Step 502: Assuming the preliminary detection state has been entered, when DT_{M} (i.e., DT for M) number of almost consecutive samples (as defined in Step 501) satisfy the condition in Step 501, then a likely event of interest is postulated by one or more of the prediction analysis modules 54 and the detection state is entered for predictions from M. Note that a likely event of interest is identified by the prediction analysis modules 54 when, for almost consecutive relative prediction errors (of a prediction error series of length at least DT), each of the relative prediction errors departs from the moving average of a plurality of past relative prediction errors by, e.g., a given percentage of their standard deviation.

Step 503: Once the start of a likely event of interest has been postulated (and the corresponding detection state entered), iteratively evaluate subsequent samples for an end of the event of interest. That is, determine when the following condition occurs: subsequent actual samples are identified whose relative prediction error becomes less than a RtNST_{M} (i.e., RtNST for M), this value being in at least one embodiment determined from a moving average of some number (e.g., 10 to 100) of past relative prediction errors. As indicated above, RtNST_{M} may be computed as a percentage of the standard deviation of the relative prediction errors (for M) used to calculate the moving average.

Note that the moving average is kept of the actual data stream's data samples prior to the start of a detected likely event of interest. When a likely event of interest is detected, adaptive updates to the prediction model cease. This prevents the suspected event of interest from becoming part of the prediction model's internal structure for predicting environmental background. Otherwise, it might become difficult to detect a similar event of interest a second time, and/or to have the predictive model appropriately predict the signal background of the environment 34. Accordingly, when a likely event of interest is detected as a consequence of one or more predictions by M, then the prediction model M may output various values (depending on invention implementation) that are related to sample data immediately prior to the likely detection of an event of interest, wherein such sample data satisfies at least one of: (i) a likely event of interest is not a consequence of a prediction from M using this sample data (i.e., M does not enter its suspended state), and/or (ii) M is not responsible for the detection of a likely event of interest when this sample data is available for use by M in providing predictions (i.e., M is not in the suspended state when using this sample data). For example, one of the following may be output as a prediction by M when a likely event of interest is detected:

(a) The prediction immediately prior to the likely event of interest being detected;

(b) The data sample immediately prior to the likely event of interest being detected;

(c) An average of a plurality of predictions immediately prior to the likely event of interest detection, wherein each of these prior predictions is obtained: (i) when the prediction model is in the normal state, and/or (ii) when the prior prediction does not result in the prediction model entering a state other than the normal state;

(d) An average of a plurality of actual data samples immediately prior to the likely event of interest detection, wherein this plurality of data samples are equated to the “sample data” above;

(e) The output of some alternative model of the portions of the output data 44 that is not indicative of a likely event of interest. An alternative model of this type approximates the output data 44 using additional known characteristics of the output data 44. For example, such a model may operationalize a control law that the output data 44 substantially follows due to the type of sensors 30 and/or the application for which the present invention is used. Thus, such alternative models incorporate additional application knowledge.

Note that output according to (d) immediately above has been found to be particularly useful in detecting the end of an event of interest.

Accordingly, when RtNDT_{M} (i.e., RtNDT for M) number of almost consecutive samples meet the criteria in Step 503, an end of the likely event of interest is postulated. Note that RtNDT_{M} is potentially different from DT_{M}.

Step 504: Assuming that the end of the likely event of interest is postulated in Step 503, the prediction analysis modules 54 return to the non-detection state regarding predictions and data samples related to the prediction model M.

When implementing the steps of FIG. 5, it is important to realize that there are several ways Steps 501 and 503 may be implemented. Note that in at least some embodiments of the invention, it has proven useful to compare the current-sample relative prediction error to the moving average relative prediction error. In particular, this comparison is done by determining the thresholds ST_{M} and RtNST_{M} as some percentage of the standard deviation of the past moving average of relative prediction errors. However, it is within the scope of the invention to use other measures of the variation in the relative prediction errors such as:

(a) The slope of a line fit to some number of past-sample RPEs and the current sample's RPE. Note that if such a slope projects the RPE as rising above a given threshold, then this may indicate a likely event of interest. Similarly, note that if such a slope is falling and is followed by a flat slope wherein the slope projects the RPE as being below a given threshold, then this may indicate the end of an anomaly.

(b) The frequency content of a most recent window of prediction errors compared to the frequency content of the past window of prediction errors.

(c) The amount of adjustment made to one of the prediction models 46 based on the current sample's RPE; e.g., a maximum change in an amplitude of one of the radial basis functions.

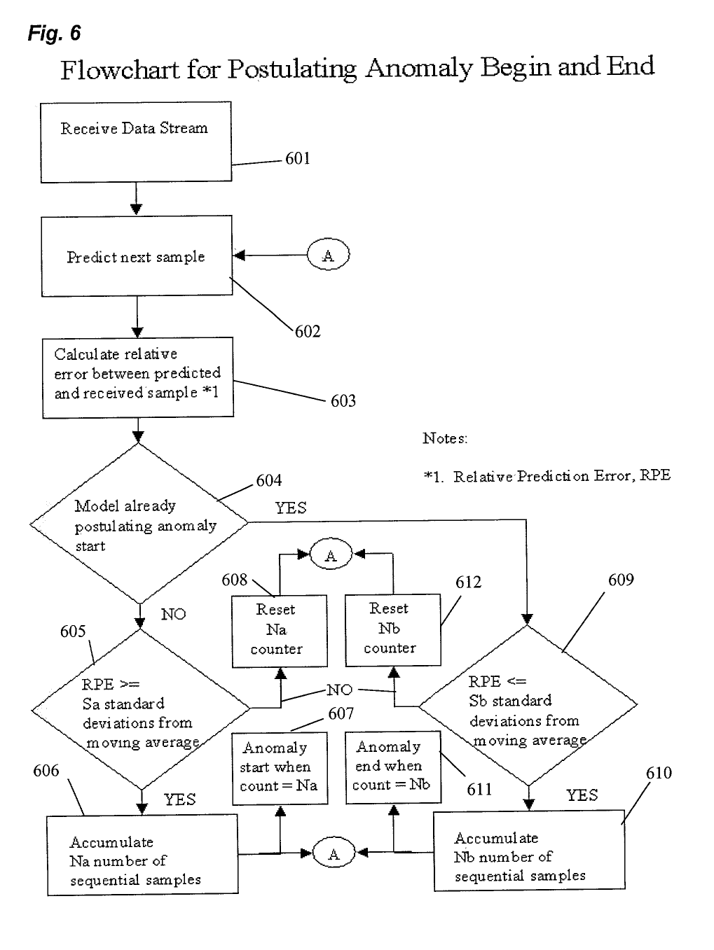

Note that the flowchart of FIG. 6 provides further detail regarding detecting the beginning and end of a likely event of interest, wherein the likely event of interest is considered to be an anomaly. Using the same notation as in the description of FIG. 5 above, the steps of this flowchart can described as follows:

Step 601: The prediction model 46 M receives data samples from its data stream.

Step 602: M predicts the next data sample of the data stream.

Step 603: The prediction analysis modules 54 calculate a relative prediction error (RPE) between the prediction of Step 601 and the next data sample of step 602.

Step 604: A determination is made as to whether M is already postulating an anomaly.

Step 605: Assuming no anomaly is currently being postulated, then in this step the prediction analysis modules 54 determine whether RPE is greater than or equal to Sa number of standard deviations of a moving average of prior windows of prediction errors; e.g., Sa may be equal to 1, and Sa number of standard deviations being equal to ST_{M}.

Step 606: Assuming the prediction analysis modules 54 determine that RPE>=Sa standard deviations, then this step increments the variable Na which is an accumulator for accumulating the number of sequential (or alternatively, almost consecutive) data samples wherein RPE>=Sa standard deviations. Subsequent to this step, steps 607 and 602 are both performed.

Step 607: If Na is equal to DT, the prediction analysis modules 54 enter the detection state for M.

Step 608: Returning to step 605, if RPE is not greater than or equal to Sa number of standard deviations, then in this step (608), the accumulator Na is reset to zero.

Step 609: If in step 604, M is already postulating an anomaly (i.e., M is in the suspended state and the prediction analysis modules are in the detection state for M), then this step (609) is performed, wherein a determination is made as to whether RPE is less than or equal to Sb number of standard deviations of a moving average of prior windows of prediction errors; e.g., Sb may be equal to 0.75, Sb number of standard deviations being equal to RtNST_{M}.

Step 610: Assuming the prediction analysis modules 54 determine that RPE<=Sb standard deviations, then this step increments the variable Nb which is an accumulator for accumulating the number of sequential (or alternatively, almost consecutive) data samples wherein RPE<=Sa standard deviations. Subsequent to this step, steps 611 and 602 are both performed.

Step 611: If Nb is equal to RtNDT, the prediction analysis modules 54 enter the non-detection state for M.

Step 612: Returning to step 609, if RPE is not less than or equal to Sb number of standard deviations, then in this step (612), the accumulator Nb is reset to zero.

An alternative technique for determining when a prediction error may be indicative of a likely event of interest, can be performed by calculating the amount of adjustment needed by a prediction model 46 M due to the difference between the predicted and actual sample values. This calculated adjustment amount is derived from performing prediction model 46 adjustments, e.g., the height of the Gaussian radial basis functions used in the prediction model. However, the absolute value of such an adjustment amount may also be used to detect likely events of interest. A description of such adjustments follows.

The general equation for radial basis functions that are used to calculate each next-sample prediction is defined in equations Eqn 1 and Eqn 2 below. A predication model 46 is adjusted by varying the height of its basis functions, e.g., varying the value of cᵢ in Eqn 1 below. Note that (as shown below) cᵢ is directly related to the prediction error and can therefore be used to postulate the beginning and end of a likely event of interest.

$$f ( x ) = {\sum }_{i = 1}^{n} [ {c}_{i} {g}_{i} ( x , {ξ}_{i} ) ] \qquad \text{(Eqn 1)}$$

Wherein

f(x) approximates function F(x) at point x. This is the next-sample prediction.

F(x) yields the actual next-sample.

ξᵢ is the center or location of basis function i

gᵢ is the basis function centered at ξᵢ

cᵢ is the height of gᵢ

n is the number of basis functions

The present implementation of this inventions uses the following basis function:

gᵢ(x,ξᵢ)=e^{-πσ}^{ᵢ}^{²}^{∥x-ξ}^{ᵢ}^{∥}^{²} (Eqn 2)

wherein ∥x−ξᵢ∥²=(x−ξᵢ)(x−ξᵢ) and σᵢ² is the variance.

In one embodiment of the present invention all the cᵢ are initialized to the same constant between 0 and 1, non-inclusive. The cᵢ (Gaussian heights) are adjusted in the following way:

cᵢₜ=c_{i[t-1]}−Kₜεₐₜgᵢ(xₜ, ξᵢ) (Eqn 3)

Wherein Kₜ and εₐₜ defined as in Eqn 4 and Eqn 5 below.

εₐₜ=εₜ−Φsat(εₜ/Φ) (Eqn 4)

wherein sat(z)=z if |z|<=1, and sgn(z) otherwise; sgn(z)=−1 if z<0 and +1 otherwise; Φ is the minimum expected error, and εₜ=(f(x)ₜ−F(x)ₜ). Note that εₜ is the prediction error, i.e., the difference between the predicted and actual next-sample.

$${K}_{t} = \frac{G}{{\sum }_{i = 1}^{n} {{g}_{i} ( {x}_{i} , {ξ}_{i} )}^{2}} \qquad \text{(Eqn 5)}$$

wherein Kₜ is the adaptation gain. The theory requires G<2. Empirically, we have found that G=0.1 works well. Kₜ must always be positive.

Adjustments to the cᵢ are the direct result of the difference between the predicted and actual next-sample (the prediction error). Because of the direct relationship between cᵢ and the prediction error, the magnitude of cᵢ can be used to detect a likely event of interest in the data stream. The cᵢ are not adjusted when the prediction model has found a likely event of interest and has put the prediction model into a suspended state. However, proposed cᵢ can still be calculated and compared to some threshold. Thus, the same logic applies to the cᵢ as applies to the prediction error itself. A likely event of interest is postulated when the cᵢ rises above some threshold (e.g., ST). The end of a likely event of interest is postulated when the cᵢ falls below some threshold (e.g., RtNST).

Thus, the threshold ST_{M} may correspond to a particular adjustment amount of the prediction model 46 M. Moreover, the threshold RtNST_{M} may similarly correspond to the amount of model adjustment that would cause the prediction model M to predict actual data samples accurately.

Additionally, in one embodiment of the present invention for detecting speech (as the likely event of interest) in a very noisy audio segment, the detection threshold, ST, was set at a 0.0006 deviation of the local squared mean, and in another embodiment for detecting visual anomalies (as the likely event of interest) in a video data stream, the detection threshold ST was set at 0.095 deviation of the local squared mean.

Note, however, that in at least some embodiments of the invention, the detection of likely events of interest is related to a standard deviation of a relative prediction error (as defined in the Definition of Terms section above). For example, the following analysis provides some insight into why a standard deviation of a relative prediction error is beneficial. Standard deviations based on prediction errors provide a way of setting the ST threshold relative to the magnitudes of RPE values in the recent past for the prediction model Such a standard deviation is a way of measuring how much from an average of recent past R_{PE} values the most recent R_{PE} must depart before a likely event of interest is declared. So, events are not detected when the R_{PE} of the current sample is within, say, one standard deviation of the average R_{PE} values for some predetermined number of previous R_{PE} values. Note that as the ST threshold gets smaller, its prediction model 46 gets more sensitive, and visa versa. It remains for application domain and requirements analysis to determine how the ST threshold relates to standard deviation measurements of R_{PE} values in order to approximately balance false positives and false negatives. Further note that when there is: (a) pre-processing of the data samples by, e.g., the sensor output filter 38, for filtering out noise, or (b) post-processing by, e.g., the modules 70 through 82, then the threshold ST may be lowered while still not presenting too many false events of interest to, e.g., the modules 84 through 92. For example, the ST threshold may be 0.95 of such standard deviations rather than 1.0 of such standard deviations.

Effective Prediction

The effective range of a sensor is based upon its ability to differentiate signals for a likely event of interest against the background of the monitored environment 34. A fixed threshold setting for detection of likely events of interest establishes a sensitivity level where there are minimum false positives. Such a fixed threshold therefore establishes a range of detection sensitivity for likely events of interest. The sensor may well detect likely events of interest below this threshold, but they are not reported because they do not exceed the threshold. The method of the present invention lets the detection threshold float and adapt on a sample-by-sample basis for more effective detection. Accordingly, as a prediction model 46 gets better at predicting the environmental background, the effective sensitivity can be increased due to the reduction in the prediction error value, thus lowering the sensor threshold. Thus for target detection, the approach of the present invention effectively increases the range at which the target could be detected by the sensor.

Since the discrepancy or prediction error between a prediction by a prediction model 46 and the corresponding actual data sample is used to determine whether a likely event of interest occurs, evaluating the effectiveness of the prediction models 46 in providing appropriate predictions is important. Accordingly, the present invention uses a number of criteria for determining when the prediction models 46 are outputting appropriate predictions. In particular, it has been determined by the inventors that the following criteria for prediction errors provide indications as to the appropriateness of predictions output by a prediction model 46 for data samples that are not indicative of a likely event of interest:

(10.1) The most recent relative prediction error R_{PE} should be within some reasonable range of a moving (window) average of past prediction errors. For instance, if the detection threshold ST is set to one STDDEV of the most recent relative prediction error from a moving average of a window of relative prediction errors, then the corresponding prediction model 46 should be outputting predictions below ST for a reasonable number of non-event of interest data samples before the prediction model transitions from untrained state to the normal state. Note that a moving average of the R_{PE} smoothes out localized spikes or outliers that are not likely to be indicative of an event of interest. Applicants have found that a moving average of the R_{PE} should be consistently less than or equal to 0.01 for best detection accuracy. It is important that there should not be large differences between: (i) the relative prediction errors grouped together in a window, and (ii) the average of that group. Accordingly, the standard deviation is a measure of how much from their average a group of R_{PE} tends to be. Applicants have found that a standard deviation of consistently less than or equal to 0.01 yields effective detection accuracy. Moreover, once a prediction model is in the normal state, a larger window for the standard deviation may be used so that the standard deviation is not too sensitive to changes in localized R_{PE} fluctuations. In this way, the standard deviation will not change radically when the local R_{PE} suddenly increases. Thus, as the standard deviation window increases, the prediction model becomes increasingly sensitive because the local R_{PE} can rise at a faster rate than the standard deviation and therefore exceed the detection threshold (ST) more readily. Furthermore, since ST may be defined as {Moving Average±(X*STDDEV)}, when X increases, the detection sensitivity decreases since it takes a larger R_{PE} to exceed ST. Note that it is also the case that, for a given X, as the window size used for the moving average and standard deviation increases, this causes an enhanced smoothing effect such that these values fluctuate less dramatically.

(10.2) There is not a growing departure of the most recent prediction error from the mean prediction error (of some window of recent prediction errors). This condition measures |M_{E}−C_{E}| where M_{E} is the moving average of past prediction errors and C_{E} is the current prediction error. For example, a line fit to a moving window of values for |M_{E}−C_{E}| should have a slope approaching zero or be decreasing.

(10.3) It is desirable to have a decreasing (or at least non-increasing) prediction error variability. To this end, a measurement of the variability of a window of prediction errors, such as the standard deviation, may be calculated by the present invention. Thus, for effective prediction, such a measurement of the variability should decrease with a decrease in the moving (window) average of the prediction error. For example, a line fit to a moving window of STDDEV values should have a slope approaching zero or be decreasing.

Accordingly, a prediction model 46 is believed to provide reliable predictions wherein such predictions can be used to distinguish likely events of interest from both uninteresting environmental states, and spurious data sample outliers. when:

(11.1) the relative prediction error stays within a stable and narrow range. For example, when the relative prediction errors within a predetermined window (of, e.g., 50 prior data samples) are such that

(MAX−MIN)<=C*(MAX+MIN)/2

wherein MAX is the maximum relative prediction error in the window, MIN is minimum relative prediction error in the window, and C is preferably less than 0.2, and more preferably less than 0.10, and most preferably less than 0.05.

(11.2) the standard deviation of the relative prediction error stays within a stable and narrow range, wherein the formula:

(MAX−MIN)<=C*(MAX+MIN)/2

is also used here, but with MAX being the maximum standard deviation of the relative prediction error in the window, MIN being the minimum standard relative prediction error in the window, and C is preferably less than 0.2, and more preferably less than 0.10, and most preferably less than 0.05.

(11.3) when at least one of the above criteria (10.1) through (10.5) are satisfied.

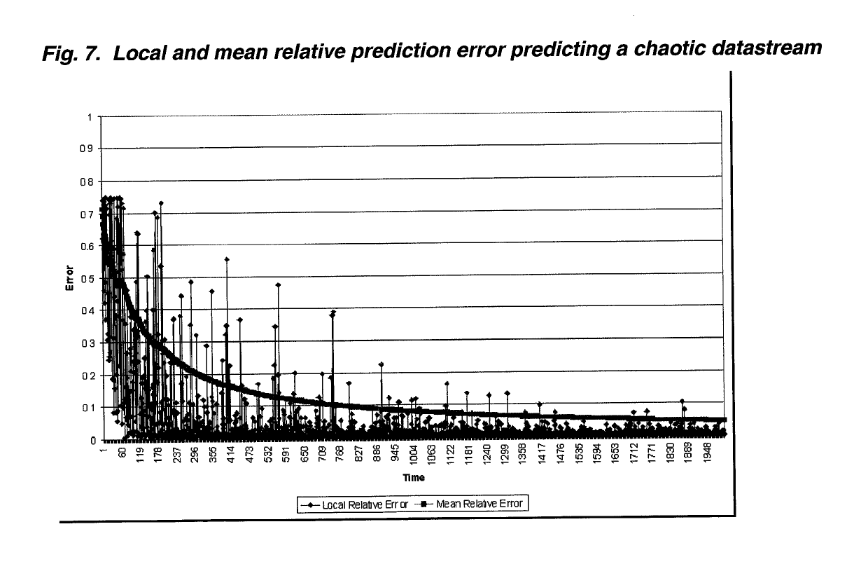

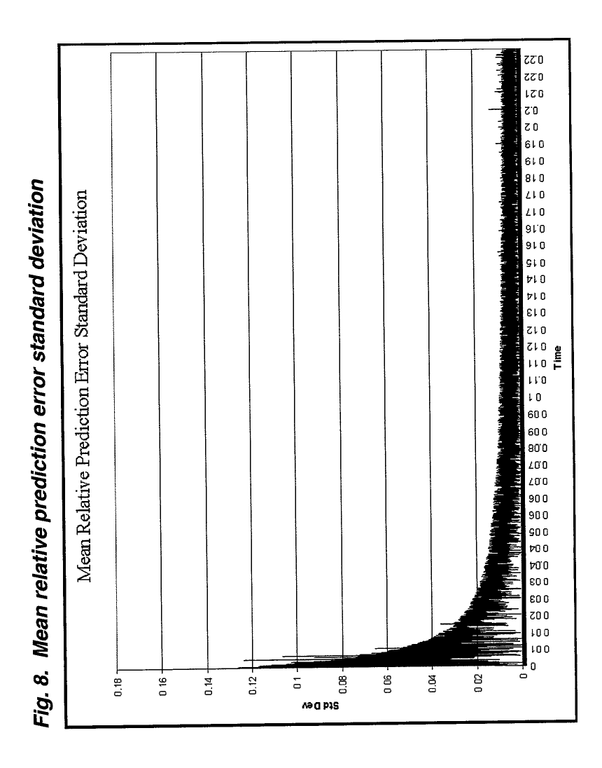

For example, for the chaotic data stream represented in FIG. 1, FIG. 7 shows the local and mean prediction error obtained from inputting the data stream of FIG. 1 into a prediction model 46 for the present invention (i.e., the prediction model being an ANN having radial basis adaptation functions in its neurons). Moreover, FIG. 8 shows a plot of the standard deviation of a window of the prediction errors when the data stream of FIG. 1 is input to this prediction model. Accordingly this example illustrates applicant's belief that the training of such prediction models, on even a chaotic data stream, can result in the model being highly effective at prediction. Thus, an anomalous event or an event of interest can be effectively postulated when corresponding prediction errors depart from a predetermined range for a predetermined number of almost consecutive data samples.

As an aside, it worth mentioning that in the case of FIGS. 7 and 8, the average and standard deviation are based on an ever-expanding window. Moreover, the windows used for the calculations of these figures increase in a manner so that the final average and standard deviation computed use a window having 32,000 points. The reason window sizes are important has to do with preventing numeric overflow during the calculation of average and standard deviation, and to control the model's detection sensitivity as one skilled in the art will understand.

Further note that the size of the window of past data samples used to calculate such a standard deviation of the relative prediction error may require analysis of the application domain. At least some of the criteria used in performing such an analysis is dependent on how often major changes in the environmental background are expected.

Training of the Prediction Models

In at least some embodiments of the present invention, the prediction models 46 must be both initially trained (as discussed hereinabove), and continually retrained so that each of the models can subsequently reliably predict future data stream data samples. Accordingly, initial training of the prediction models 46 will be discussed first, followed by retraining.

Initial Prediction Model Training

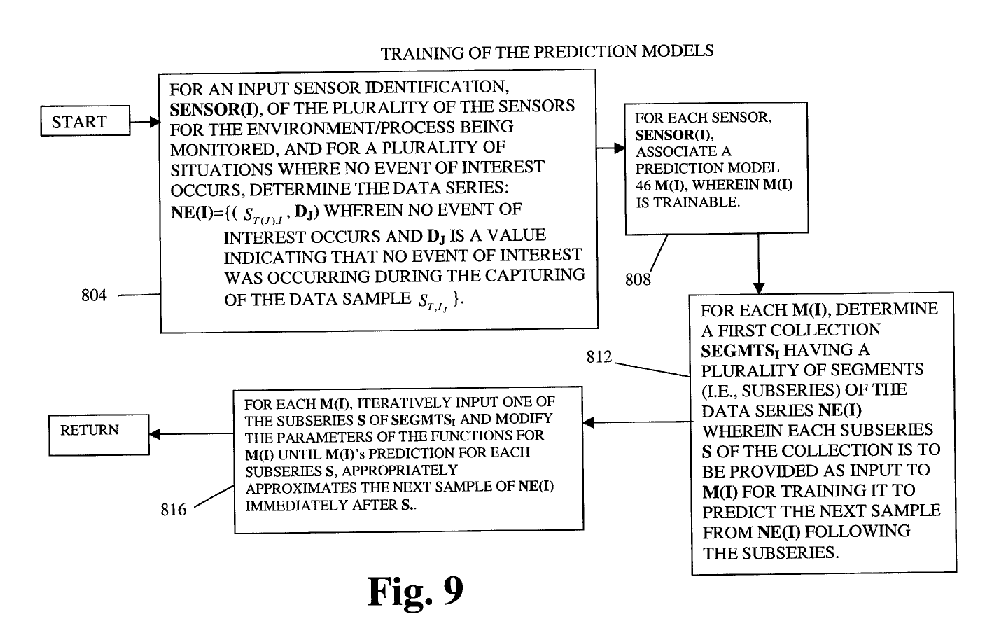

FIG. 9 provides an embodiment of the high level steps performed for initially training the prediction models 46. In particular, it is assumed that for each of the sensors 30 there is a unique data stream of data samples provided to a uniquely corresponding prediction model 46. Accordingly, in step 804 of this figure, for each sensor 30 (SENSOR(I)) a data series (NE(I)) is captured that is believed to be representative of various situations and/or conditions in the environment 34 being monitored wherein such situations and/or conditions have no event of interest occurring therein. Subsequently, in step 808, for each sensor 30 (SENSOR(I)), a trainable prediction model 46 (M(I)) is associated for receiving input for the data series NE(I). Note that such associations may be embodied using message passing on a network. Further note that in one embodiment of the present invention, the prediction models are ANNs having weights therein that are dependent on one or more radial basis functions. Additionally note that a technique for determining the size (e.g., the number of radial basis functions) of a prediction model 46 is disclosed in U.S. Pat. No. 5,268,834 by Sanner et. al. filed Jun. 24, 1991 and issued Dec. 7, 1993, this patent being fully incorporated herein by reference. However, applicants have found that for many applications for the signal processing method and system of the present invention, the performance of a prediction model 46 is not strongly dependent on the number of terms (e.g., radial basis functions).

In steps 812 and 816, a plurality of subseries of each NE(I) is used to train the corresponding prediction model 46. Note that such training continues until there is effective data sample prediction as described in the Effective Prediction section hereinabove.

In various embodiments of the present invention there may be different criteria that may be used for determining when a prediction model 46 has been adequately initially trained. In one embodiment, the following criteria may be used:

(12.1) A line fit to the average range—relative prediction error (ARRPE), as defined in the Definition of Terms section hereinabove, has a slope that is zero or decreasing. This is related to (10.3) above.

(12.2) The AARPE should be below 0.1, and more preferably below 0.075, and most preferably below 0.05.

(12.3) The average of the absolute value of the standard deviation of the relative prediction error (R_{PE}) should be less than or equal to 1.

(12.4) A line fit to the average of the absolute value of the R_{PE} standard deviation (of a predetermined window size) has a slope that is zero or decreasing. This is related to (10.2).

However, analysis of the application domain may cause a modification of the criteria (12.1) through (12.4).

Retraining of Prediction Models

As previously described, prediction models 46 are continually trained whenever they are in the normal state. However, it may be the case that a data stream causes a prediction model 46 to enter the suspended state and substantially stay in this state. Accordingly, embodiments of the present invention may also retrain such a prediction model on the presumed likely event of interest data stream if, e.g., it is determined (e.g., through an independent source) that no event of interest is occurring.

Event of Interest Detection

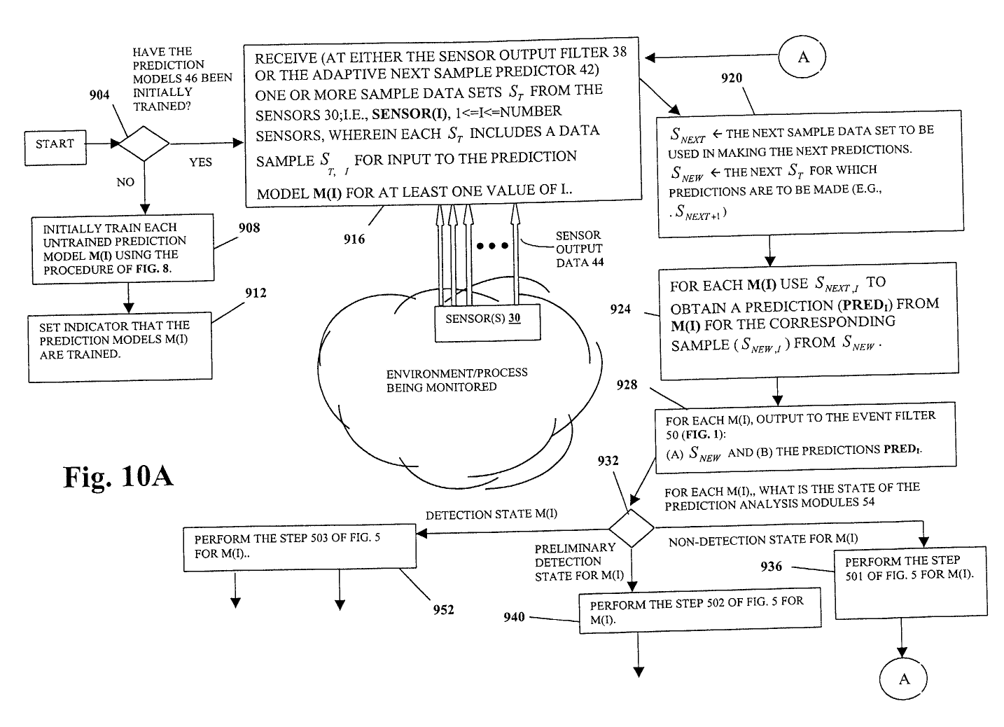

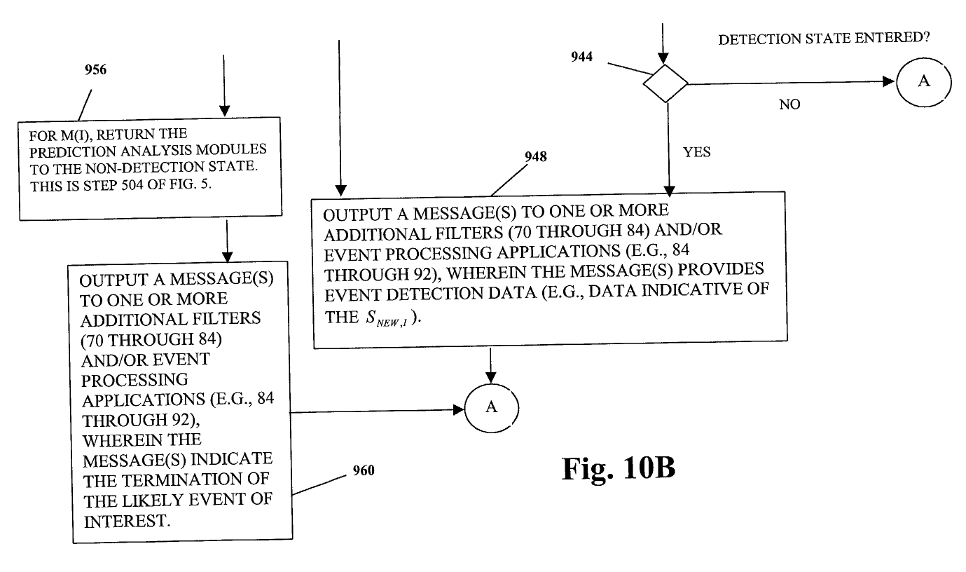

FIGS. 10A and 10B provide a flowchart showing the high level steps performed by the present invention for detecting a likely event of interest. Accordingly, assuming the appropriate prediction models 46 have been created, in step 904 a determination is made as to whether each of these prediction models 46 has been initially trained. If not, then step 908 is performed, wherein each untrained prediction model 46 M(I) is trained according to the flowchart of FIG. 8. Subsequently, in step 912, an indicator is set that indicates that all the prediction models M(I) are trained.

Alternatively, if it is determined in step 904 that all the predictive models 46 have been trained, then in step 916 the sensor output filter 38 or the adaptive next sample predictor 42 receives one or more sample data sets, S_{T}, from the sensors 30 (these sensors denoted as SENSOR(I), 1<=I<=the number of sensors 30). In particular, each sample data set S_{T} includes a data sample S_{T,I} for inputting to the prediction model 46 M(I) (for at least one value of I). In one embodiment, S_{T} may be the set of data samples output from each of the sensors 30 at time T, and S_{T,I} is the corresponding data sample from SENSOR(I). Subsequently in step 920, the identifier S_{NEXT} is assigned the next sample data set to used by the prediction models M(I) in making predictions. It is assumed for simplicity here that each of the prediction models M(I) has a corresponding input data sample S_{T,I} in S_{NEXT}) and that each of the M(I) are capable of generating a prediction if supplied with S_{T,I}. Additionally, the identifier S_{NEW} is assigned the subsequent sample data set for which predictions are to be made; i.e., S_{NEXT+1}. Moreover, assume for simplicity that S_{NEW} contains a data sample S_{NEW,I} for each M(I). Accordingly, in step 924, each M(I) uses its corresponding data sample S_{NEXT,I} to generate a prediction PRED_{I} of S_{NEW,I}.

In step 928, S_{NEW} and the set of predictions PRED_{I} are output to the prediction engine 50. Subsequently in step 932, for each M(I), a determination is made as to the state of the prediction analysis modules 54 regarding predictions from M(I); i.e., the prediction analysis modules 54 are in which of the following states (for PRED_{I}): the non-detection state, the preliminary detection state, or the detection state. If the prediction analysis modules 54 are in the non-detection state, then in step 936, step 501 of FIG. 5 is performed. Following this step 916 is again encountered. Alternatively, if the prediction analysis modules 54 are in the preliminary detection state, then in step 940, step 502 of FIG. 5 is performed. Moreover, note that step 502 iteratively performs steps that are duplicative of steps 916 through 928. Subsequently, in step 944 a determination is made as to whether the detection state has been entered. If not, then step 916 is again encountered. However, if the detection state is entered, then step 948 is performed, wherein a message (or messages) is output to one or more additional filters 70 through 84 (or the event processing applications 84 through 92) for further identifying and/or classifying a likely event of interest detected, Note that a plurality of the prediction models 46 may simultaneously provide predictions that are sufficiently different from their corresponding data samples so as to induce the prediction analysis modules 54 to generate such a likely event of interest message for each of the data streams corresponding with one of the plurality of prediction models. Subsequently, step 916 is again encountered.

Referring to step 944 again, if the prediction analysis modules 54 enter the detection state, then in step 952, step 503 of FIG. 5 is performed, wherein the prediction analysis modules remain in the detection state until the prediction errors for each prediction model 46 M(I) is, e.g., below its corresponding threshold RtNST(I). Subsequently, in step 956, the prediction analysis modules 54 return to a non-detection state with respect to the data stream and predictions for M(I). Following this, step 960 is performed wherein an end of likely event of interest message (or messages) is output to one or more additional filters 70 through 84 (or the event processing applications 84 through 92) that received a message(s) that the likely event of interest was occurring, Subsequently, step 916 is again encountered.

Hardware

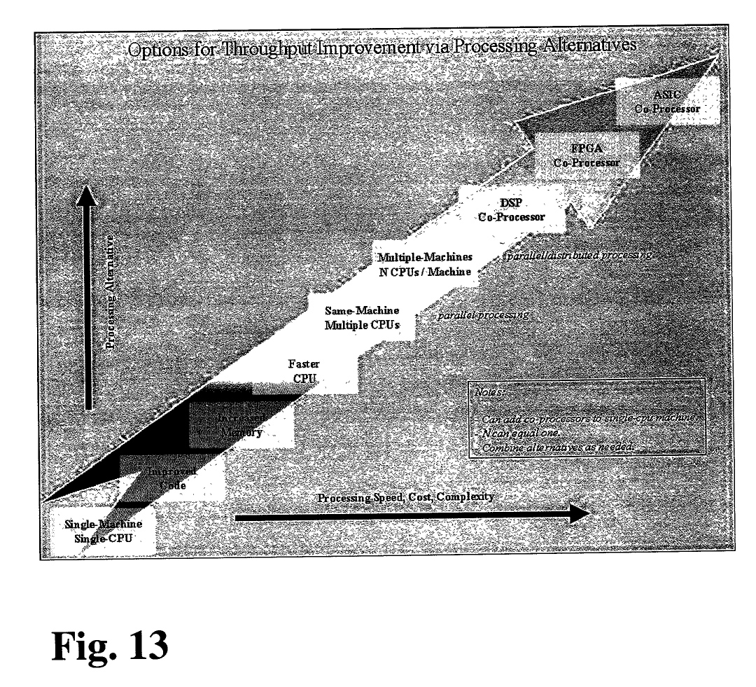

The hardware implementation options for the present invention, range from the use of single-processor/single-machine structures through networked multi-processor/multi-machine architectures having a combination of shared and distributed memory. The (hardware intensive) architectures of the present invention include co-processors constructed of digital signal processors (DSPs), field-programmable gate arrays (FPGAs), systolic arrays, or application-specific integrated circuits (ASICs). Massively-parallel and/or class super computers are a part of these options since they can be viewed as single-machine/multi-processor or multi-machine/multi-processor architectures. For different ones of these hardware implementation alternatives, there are different corresponding software architectures for taking advantage of the available hardware to enhance the performance of the present invention. Co-processors may be assigned to computationally-intense tasks, or such tasks may be performed outside the supervision of network or general computer operating systems. Moreover, such specialized computing components maybe used as needed depending on the basic hardware infrastructure; e.g., there is no reason that a co-processor could not be added to a simple single-machine/single-CPU architecture. Additionally, a “co-processor” can be used to map an embodiment of the invention to small size distributed applications. Moreover, high-speed networks can be used to improve data flow from the sensor to an embodiment of the invention and/or between its components. FIG. 13 shows how various hardware implementations bring expanded speed, complexity, and cost, along with the need for greater computer engineering skill to implement the invention.

Parallel Architectures

Since the present invention may effectively utilize a parallel/distributed computational architecture for computing predictions by the prediction models, a number of parallel architectures upon which an embodiment of the present may be provided will now be discussed.

There are at least three versions of parallel architecture for the present invention.

These are:

(A) One CPU/One Machine. This version is the most simple. The invention runs the models and outputs the results via a single CPU. Any parallelism is simulated.

(B) Multiple CPUs/One Machine. This version performs parallel processing on multiple processors on a single machine. This version does not have the capability to trigger additional machines. It is assumed here that memory is shared amongst the various processors.

(C) Multiple CPUs/Multiple Machines. This version extends the parallel processing architecture to take advantage of clustered machines. An embodiment of the invention for use here may have the ability to send data streams across the network to helper machines and receive their results. It is assumed that each machine's processors share a single memory and that the memory for each machine is separate from that of other machines. This creates a shared/distributed memory structure. However, the hardware architecture here does not preclude the various machines from sharing a single memory.

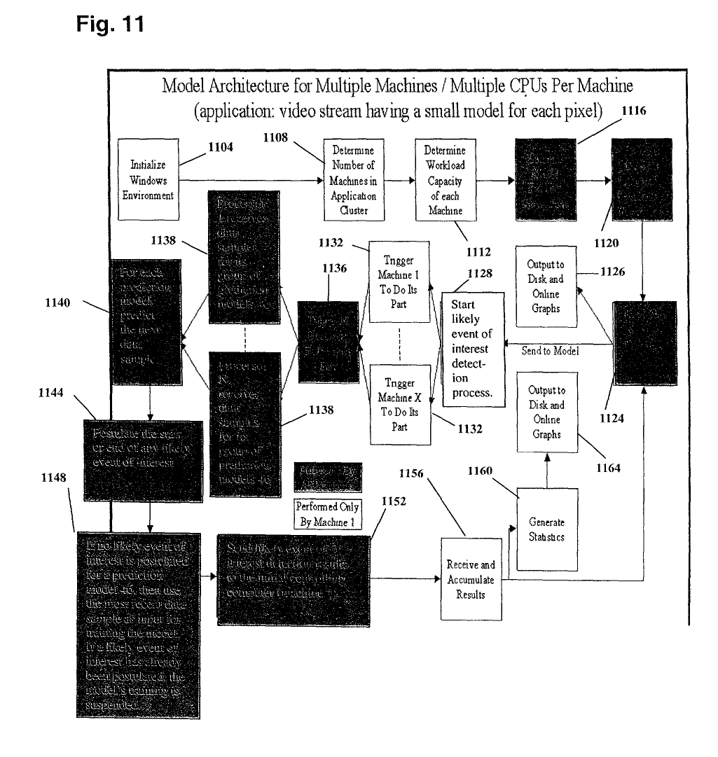

Note that FIG. 11 illustrates the steps performed for configuring an embodiment of the invention for any one of the above hardware architectures and then detecting likely events of interest. In particular, FIG. 11 illustrates the steps performed in the context of processing data streams obtained from pixel elements. However, one skilled in the art will understand that similar steps are applicable to other applications having a plurality of different data streams.

Accordingly, the steps are described as follows:

Step 1104: Assuming a controlling computer having, e.g., an operating system such as the Microsoft WINDOWS operating system (although other operating systems such as UNIX can be used, as one skilled in the art will understand), the controlling computer configures the (any) other networked computers used to detect a likely event of interest in (e.g., video) input sample data by initializing the WINDOWS environment: The controlling computer is then prepared to run the event detection application of the present invention. Accordingly, operator console(s) for the controlling computer having graphical user interfaces (GUIs) displayed thereon, appropriate input and output files are opened on the controlling computer, and application-specific variables are initialized.

Step 1108: The controlling computer determines the number of machines available in a cluster of networked computers used to perform the video processing: Subsequently, communications are established with any of the other computers of the cluster with which the controlling computer has to communicate. Once the controlling computer establishes communications with these other computers of the cluster with which it has to communicate, the controlling computer obtains a count of the number of the other computers in the cluster since it may communicate with each of these other computers. Note that the other (any) cluster computers (also denoted non-host or worker computers) only have to communicate with the controlling computer in at least some of the implementations of the invention.

Step 1112: The controlling computer determines the workload capacity of each of the other computers of the cluster: As each of the computers to be used is configured in Step 1104, it reads a workload capacity variable from a file that indicates its workload capacity. For each computer used, one means of determining the value of the workload capacity variable is for an operator to make a judgment of the run-time capabilities of the computer for a given stand-alone application. The lower a computer's capacity, the longer it will take to run the application, and accordingly, the higher is the workload capacity variable. Worker machines send this value to the controlling computer. The controlling computer receives each such value and stores it in a table that relates the value to its corresponding computer. The total cluster workload capacity for the cluster is the sum of all the workload capacity variables from the various cluster of computers. Note that the number of prediction models 46 that a given computer processes is calculated as a fraction of that computer's share of the total cluster workload capacity:

(total_number_of_models*machineX_cluster_capacity_fraction).

In one embodiment, the cluster workload capacity for a computer X is:

(1−(machineX_capacity/total_cluster_capacity)).

Step 1116: In each computer C of the cluster, initialize the prediction models 46 to be processed by C: In particular, the controlling computer communicates to each worker computer the number of prediction models 46 it will perform. The controlling computer also passes to each worker computer the parameters to be used by the (any) predictions models 46 that the worker computer is to perform. These parameters may include the number of basis functions for each of the (ANN) prediction models 46 to be proceeded by the number of worker computers, the training rate, and the thresholds ST, DT, RtNST, and RtNDT. Each cluster computer (that processes prediction models 46) uses such parameters to create and initialize the objects, matrices, vectors, and variables needed to run their corresponding prediction model(s) 46.

Step 1120: Denote each computer of the cluster that processes at least one prediction model 46 is denoted herein as a “prediction machine”. In this step each prediction machine has the runtime environment for its prediction model(s) 46 initialized: Each prediction machine has one or more CPUs that will be used to execute the code for of its prediction model(s) 46. Each prediction machine queries its operating system to find out how many CPUs it has. It then creates one or more processes for processing one or more assigned prediction models 46, wherein each such process is for a different CPU of the prediction machine. In some implementations of the invention there may be more or less such processes than there are CPUs in a prediction machine, and the number of such processes may be determined by a human operator.

Step 1124: The controlling computer receives the next frame, wherein the word “frame” is used here to identify the most recent data sample output from each the sensors 30. Depending on the embodiment of the present invention, such data samples may be pixels of an image, input from various audio sensors in a grid. or some collection of heterogeneous sensors (e.g., video, audio, thermal and/or chemical). Accordingly, it is within the scope of the invention to obtain the data samples 44 from one or more types of sensors 30. Depending on the arrangement of the hardware of the adaptive next sample predictor 42 and/or the sensor output filter 38, it is possible that each frame is captured in a buffer. Such buffering of frames may enable a simple technique for grouping data samples into frames, particularly when the sensors 30 may provide data samples at different rates.

Step 1126: Upon receiving a frame, this step outputs the received frame to archival storage and/or to a display (i.e., a GUI):. Note that other transformations of received frames can also be stored and/or displayed. For instance, edge detection could be performed for an image and an FFT result could be performed on an audio signal.

Step 1128: Start the likely event of interest detection process: Note that once Step 1126 is completed, the controlling computer enters a routine through which it supervises the completion of all processing on the most recent received frame.

Step 1132: Trigger processing on prediction machines 1 through X: Assuming there are X prediction machines (besides the controlling computer) in the cluster, the controlling computer sends to each of X prediction machines their share of the most recent frame for the corresponding prediction models 46 initialized thereon in Step 1116. In one embodiment, this amounts to one sensor sample per model prediction 46. Accordingly, for image sample data, there would be a different data sample for each pixel sent and each data sample is sent to a specific prediction model. Note that in an alternate embodiment, each frame can be received by each prediction machine and each prediction machine determines what part of the frame to process based on their initialization in Step 1116.

Step 1136. For each prediction machine, trigger one or more CPUs to process their share of the samples received from the controlling computer.

Step 1138: For each prediction machine P, P partitions its data samples among its processors, one sample per prediction model 46 designated to be processed by P.

Step 1140: For each prediction model 46, compute a corresponding next-sample prediction.

Step 1144: Postulate the start or end of any likely event of interest: To perform this step each prediction model 46 outputs its prediction to an instance of the prediction engine 50 (FIG. 3) where Using the previous prediction and comparing to the present sample, postulate the start or end of any likely event of interest. This is based on the detection thresholds previously described.

Step 1148: If no likely event of interest is postulated for a particular detection model then use the most recent data sample as input for training the model: The difference between the predicted and actual sample is used as previously described to continue the training of the prediction portion of the detection model.

Step 1152: Send likely event of interest detection results to the host computer. Each host sends a set of bits back to the host. Each bit represents a sample. A low bit indicates no detections for that sensor. A high bit indicates a positive detection for that sensor. The “bit set” can take the form of a set of Boolean or other variable types, or be actual bits of such types. In any case, it is not necessary to return a number of bits equal to the number required to represent the sensor data.

Step 1156: Receive and accumulate results at the host computer: While the host computer is waiting for the worker machines to process their data, the host can be carrying out any number of tasks. For instance, it can be displaying the current frame, storing the previous frame, and/or processing a portion of the sensor data. It really depends on the implementation. Fewer activities carried out in a purely sequential manner typically leads to increased throughput. When the worker machines are finished processing their portion of the sensor data, they send the results to the host. The host receives these results and accumulates them for display and storage. A worker's machine number indicates which group of sensors it was working on. Thus, it is not necessary to receive worker machine results in any particular order.

Step 1160: Generate statistics: Once the results are accumulated, it is possible to generate a number of statistics that are application based. For instance, it might be interesting to know how many detections there were relative to the number of sensors. It may also be interesting to generate a latitude/longitude list for the detections if the geographical location of each sensor is known. The number of detections that are geographically contiguous may also be desired. It is also possible to go to a higher level of information and indicate such things as “movement in hallway z”, “apparent activity in volcano y”, “unexpected sound in grid coordinate w”.

Step 1164: Output statistics to storage and/or a display device (i.e. graphical): Once results are accumulated and statistics calculated, they can be stored and displayed as needed. For instance, the operator may want to see before and after representations of the sensor data. Thus, a detection frame can be displayed along side the original frame. A detection location list can be displayed along with any other statistic or higher-level information. All information can be stored for archival purposes.

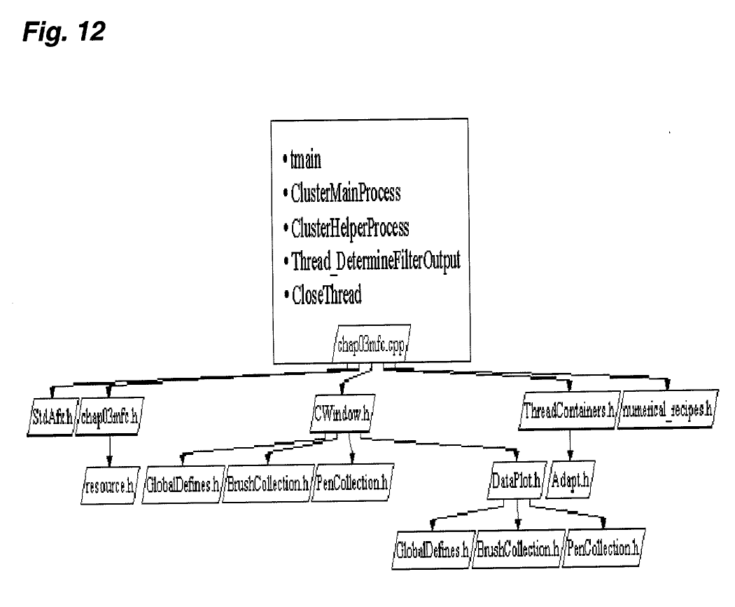

Note that an embodiment of the invention providing the steps of FIG. 11 is implemented as object oriented software written in Visual C++ for Windows NT. Moreover, note that an important part of at least one embodiment of the present invention is that each of the system architecture versions (A) through (C) above are provided by the same basic set of object classes. The difference between these versions lies in the inclusion of front-end routines for processor and cluster management. A top-level view of the classes that implement the parallel architecture (and the steps of FIG. 11) is shown in FIG. 12. The front-end routines that are added or expanded as the architecture evolves are on Level 1. They are described as follows:

tmain. This is the main process called by the operating system to activate an embodiment of the invention. This process calls front-end routines as appropriate to the number of processors and networked machines. These receive results for accumulation, display, and storage. When the embodiment is configured for only one machine, this routine partitions the pixels to the various processor threads. When configured for only one processor, this routine takes the place of the thread routines. Note that even though the hardware configuration may include multiple CPUs and multiple machines, tmain can be set to use only one machine and/or only one processor. Accordingly, this embodiment of the invention may be able to be straightforwardly ported to various hardware configurations.

Thread_DetermineFilterOutput. This routine manages the threads running on the various processors on a single machine. This routine sends data sample information to the prediction models and the prediction analysis modules. Then causes the results to be accumulated in the data archive as well as alerting any downstream processes.

CloseThread. This is a very short in-line function that simply closes an instance of Thread_DetermineFilterOutput.

ClusterHelperProcess. In the case of a networked cluster of machines, this routine is called on each machine that is not the machine having the supervisor/controller thereon (i.e., the host machine). This routine receives data sample information and distributes it to the various internal processor threads of a machine. Then it returns its results to the host.

ClusterMainProcess. In the case of a networked cluster of machines, this routine is called if the machine is the host. This routine sends data sample information to the various helper machines as well as any processes (threads) that internally process data sample information via prediction models. Subsequently, this routine may receive results from the helper machines and may create a filtered image for display and/or storage.

Prediction Model Types

There are many prediction methods that may be used in various embodiments of the prediction models 46. Some have been discussed hereinabove such as ANNs having radial basis functions. Additional prediction methods from which prediction models 46 may be provided are described hereinbelow.

Moving Average/Median Filter Models

A simple prediction model 46 may be provided by an embodiment of a moving average method. This method makes use of a moving window of a predetermined width to roughly estimate trends in the sample data. The method may be used primarily to filter or smooth sample data, which contains, e.g., unwanted high-frequency signals or outliers. This filtering or smoothing may be performed as follows: for each window instance W (of a plurality of window instances obtained from the series of data samples), assign a corresponding value V_{W} to the center of the window instance W, wherein the value V_{W} is the average of all values in the window instance W. In particular, the corresponding values V_{W} are known as moving averages for the window instances W. Thus, such moving averages V_{w} dampen anomalous variations in the sample data, and can provide an estimate (i.e., prediction) of a trend in the sample data. Accordingly, a prediction model 46 can be based on such a moving average method for thereby predicting if a next data sample, ds, is some set deviation (e.g., standard deviation) from the moving average V_{W} of the series of data samples of the window instance W immediately preceding ds. Note that another simple prediction model 46 may be provided by using a method closely related to the moving average method, i.e., a median filter method, wherein the value V_{W} of each window instance W is the median of the data samples in the window instance W.

Another variation uses a weighted moving average instead of the simple moving average described in the paragraph immediately above.

Box-Jenkins (ARIMA) Forecasting Models

Prediction models 46 may also be provided by forecasting methods such as the Box-Jenkins auto-regressive integrated moving average (ARIMA) method. A brief discussion of the ARIMA method follows.

A predetermined data sample series can often be described in a useful manner by its mean, variance, and an auto-correlation function. An important guide to the properties of the series is provided by a series of quantities called the sample autocorrelation coefficients. These coefficients measure the correlation between data samples at different intervals within the series. These coefficients often provide insight into the probability distribution that generated the data samples. Given N observations in time x₁, . . . ,x_{N}, on a discrete time series of data samples, N−1 pairs can be formed, namely (x₁, x₂), . . . ,(x_{N-1}, x_{N}). The auto-correlation coefficients are determined from these pairs and can then be applied to find the N+1 term as one skilled in the art will understand.

ARIMA methods are based on the assumption that a probability model generates the data sample series. These models can be either in the form of a binomial, Poisson, Gaussian, or any other distribution function that describes the series. Future values of the series are assumed to be related to past values as well as to past errors in predictions of such future values. An ARIMA method assumes that the series has a constant mean, variance, and auto-correlation function. For non-stationary series, sometimes differences between successive values can be taken and used as a series to which the ARIMA method may be applied.

Regression Models

Prediction models 46 may also be provided by developing a regression model in which the data sample series is forecast as a dependent variable. The past values of the related series are the independent variables of the prediction function, Pₜ=f(Sₜ₋₁, Sₜ₋₂, . . . , S_{W}).

In simple linear regression, the regression model used to describe the relationship between a single dependent variable y and a single independent variable x is y=A₀+A₁x+ε, where A₀ and A₁ are referred to as the model parameters, and ε is a probabilistic error term that accounts for the variability in y that cannot be explained by the linear relationship with x. If the error term ε were not present, the model would be deterministic. In that case, knowledge of the value of x would be sufficient to determine the value of y. A simple linear regression model is determined by varying the A₀ and A₁ until there is a best fit with a collection of known pairs of corresponding values for x and y being modeled.

In a multiple regression analysis, the model for simple linear regression is extended to account for the relationship between the dependent variable y and p independent variables x₁, x₂, . . . , xₚ. The general form of the multiple regression model is y=A₀+A₁x₁+A₂x₂+ . . . +Aₚxₚ+ε. The parameters of the model are the A₀, A₁, . . . , Aₚ, and ε is a probabilistic error term that accounts for the variability in y that cannot be explained by the linear relationship with x₁, x₂, . . . , xₚ. A multiple regression model is determined by varying the A₀, A₁, . . . , Aₚ until there is a best fit with a collection of known tuples of corresponding values x₁, x₂, . . . , xₚ, y being modeled. Once either a simple or multiple regression model instance is initially posed as a hypothesis concerning the relationship among the dependent and independent variables, the model parameters must be determined to an accepted goodness of fit. A least squares method is the most widely used procedure for developing these estimates of the model parameters. For simple linear regression, the least squares estimates of the model parameters A₀ and A₁ are denoted a₀ and a₁. Using these estimates, a regression equation is constructed: y′=a₀+a₁x. The graph of the estimated regression equation for simple linear regression is a straight-line approximation to the relationship between y and x. Once the best fit function has been determined (e.g., via least squares), the resulting regression model can used to predict future values of the series. For example, given values for x₁, x₂, . . . , xₚ as the most recent sequence of data samples, such values can be input into a regression model to thereby predict the next data sample as the value of y.

Bayesian Forecasting and Kalman Filtering Related Models

Prediction models 46 may also be provided by using a Bayesian forecasting approach. Such an approach may include a variety of methods, such as regression and smoothing, as special cases. Bayesian forecasting relies on a dynamic linear model, which is closely related to the general class of state-space models. The Bayesian forecasting approach can use a Kalman filter as a way of updating a probability distribution when a new observation (i.e., data sample) becomes available. The Bayesian approach also enables consideration of several different models but it is required to choose a single model to represent the process, or alternatively, to combine forecasts which are based on several alternative models.

The prime objective for prediction models 46 using Bayesian forecasting having a Kalman filteris to estimate a desired signal in the presence of noise. The Kalman filter provides a general method of doing this. It consists of a set of equations that are used to update a state vector when a new observation becomes available. This updating procedure has two stages, called the prediction stage and the updating stage. The prediction stage forecasts the next instance of the state vector using the current instance of the state vector and a set of prediction equations as an estimation function. When the new observation becomes available, the estimation function can take into account the extra information. A prediction error can be determined and used to adjust the prediction equations. This constitutes the updating stage of the filter. One advantage of a Kalman filter in the prediction process is that it converges fairly quickly when the control law driving the data stream does not change. But, a Kalman filter can also follow changes in the series of data samples where the control law is evolving through time In this way, the Kalman filter provides additional information to the Bayesian Forecaster.

Other Artificial Neural Network Models

Prediction models 46 may also be provided by using artificial neural networks (ANNs) other than ANNs that are just feed-forward and composed of radial basis functions. For instance, prediction models 46 may also include ANNs that adapt via some form of back-propagation as one skilled in the art will understand.

A Filter Based Embodiment

An embodiment of the present invention may be used as an information change filter/detector, wherein such a filter is used to detect any unexpected change in the information content of a data stream(s). That is, such a filter filters out expected information, detecting/identifying when unexpected information is present. This may provide an extremely early “something is happening” detection system that can be useful in various application domains such as medical condition changes of a patient, machine sounds for diagnosis, earthquake monitors, etc. Note that in most filter applications, the filter looks for a predetermined data pattern. However, detecting the unexpected may identify something at least equally important.

Applications

There are numerous applications for the signal processor described hereinabove. For example, as planes fly faster, ships sail more quietly, and as camouflage, concealment, and deception techniques make early detection more difficult, the present invention provides a measurable improvement in detection range and sensitivity. For example, an early detection radar can detect an attack aircraft at 100 miles using normal techniques. Our technique may potentially extend the detection range by 10 or 20 miles, due to the dynamic thresholding capability, thus increasing the usable sensitivity of the radar by adapting to the background signal and finding targets that would normally be hidden because they fell below a fixed threshold.

In the commercial world, locating anomalies early can result in cost savings or lives saved. Any application that depends upon value measurement and uses fixed threshold detection schemes could be potentially improved with this technology. For example, consider a bottling plant that uses a sensor to measure the quantity of beverage that goes into individual bottles. Due to the noisy environment in the bottling plant, the filling sensor may use a fixed threshold to fill each bottle in order to guarantee that a minimum amount is added to each bottle. However, the signal processor of the present invention may be used to adjust the fill level for each bottle by just two or three milliliters per bottle because it could resolve the fill measurement more accurately by adapting to the plant noise. If the plant produced a million bottles a day, the savings could reduce the daily cost of production by the quantity needed to fill a thousand bottles.

Another application of the signal processor of the present invention is for search and rescue radio signal detection. Radios used in search and rescue are affected by natural phenomena such as sunspots and thunderstorms and other electromagnetic influences. The signal processor of the present invention could be used to constantly adapt the receivers to the changing signal conditions due to these occurrences. By keeping these receivers constantly tuned for increased sensitivity, a weak signal from a person in trouble may be found, where it would not have been detected without the use of the signal processor of the present invention. In conditions where peoples lives depend on minutes and hours, such improvement in commercial detection systems can save lives.

Additionally, in any application where large amounts of data or information exists, such that most of the data is just background noise, the present invention provides a predictable method of finding potentially useful (i.e., interesting) information amongst a mass of uninteresting data. Since the present invention provides an automated technique for discriminating between interesting and uninteresting data, the large amounts of input data can be sifted quite effectively.

Within the application domain of adaptive automation, time series analysis is a well recognized approach to providing decision support in rapidly evolving situations. Sensor data can be viewed as a numeric sequence that is produced over time. Thus, time series analysis can be used to observe these sequences and provide estimations of how the sequence will evolve. Deviations from the expectation can be used to flag signals of interest. This provides a sensor-independent and domain-independent first-cut filter that can find unspecified anomalies in unspecified data streams.

Four additional applications of the present invention are briefly discussed below.

(a) Identification of deviant signatures

(b) Camouflage countermeasures

(c) Early detection of missile launches

(d) Early warning of aerosol chemical and biological attack

Each of these four applications is described hereinbelow.

Application: Identification of Deviant Signatures

Applications (e.g., mechanical and biological) that have typical characteristic signatures, wherein it is desirable to identify a deviant signal signature. In many cases, these signatures can be observed using existing sensor technology. It may be possible to predict characteristic signatures over time, based on historic observations. Significant deviations from the expected signature may indicate an impending failure. Examples of such applications are: bearing failure, gas or liquid mixture deviations, heart rhythm deviations, ambient sound deviations in high-noise environments, temperature deviations, change detection in dynamic image streams.

Accordingly, by utilizing an embodiment of the present invention failures may be predicted before they actually occur. This could save downtime and the cost of catastrophic failure. This approach is general enough that it can detect previously unobserved deviation or failure modes. Note that an appropriately chosen adaptation rate would prevent the model from evolving to the point where an impending failure would not be recognized as a deviation from the norm. For example, if the adaptation rate is set too high, the prediction model changes so quickly that the data indicating the fault or deviation is “learned” as part of the normal data stream. A too-fast adaptation rate can also cause the prediction model to “thrash” its internal variables, causing them to undergo wild variations. It is possible for the deviation to occur at such a slow rate relative to the model's adaptation rate that the deviation could go unnoticed. If the adaptation rate is much faster than the evolution of a deviation, the deviation could be missed. Much also depends, though, on how many deviant samples are counted prior to “confirming” the presence of an anomaly. While these samples are being counted, the model is still training. Training only stops when the model marks the start of an anomaly.

Application: Camouflage Countermeasures

A “scene” can be built and displayed based on any spectrum including radar, infrared, and visual ranges. It is commonplace to attempt to camouflage a target in such a way that it can enter the scene without being detected. A prediction model 46 of a target-free scene can be built and allowed to evolve as such a scene evolves. A target entering the scene may provide a sufficiently deviant signal signature from the expected scene data samples that detection of the target is assured. Note that the present invention has application for both satellite and ground-based target detection applications.

Application: Early Detection of Missile Launches

One of the difficult problems in ground-to-ground missile defense is launch detection and subsequent target tracking. Satellites gathering data over likely launch sites could be used to provide information for building and maintaining a model of non-launch conditions. Conditions that deviate from those predicted by prediction models 46 of the present invention may be used to indicate launch activity. Additionally, the target could be tracked because during flight it would likely be a departure from the non-launch conditions.

An embodiment of the present invention may be used to develop predictive models 46 of the non-launch background from archived mapping and/or scene data. Then, the embodiment could be used to predict the next background frame. Deviations from the expected background frame would be identified. The embodiment could be allowed to continue to adapt as the background evolves. This would account for normal evolution of the background over time. An appropriately chosen adaptation rate would make it unlikely that a launch could occur or that a target could enter the scene slowly enough that it would be considered part of the evolving background. The same line of thinking applies to such events as volcanic activity, and the detection of range and forest fires.

Application: Early Warning of Aerosol Chemical and Biological Contaminants

The present invention may be utilized in the detection of contaminants end/or pollutants. Once a contaminant is released, it can enter an area undetected. Environmental signature data may be used by an embodiment of the present invention to detect such a contaminant by training the prediction models 46 on the ambient environment surrounding the area. Then, this environment may be sampled and compared with the evolving prediction models. A deviation between the expected and actual conditions may indicate a contaminant has entered the area. An appropriately chosen adaptation rate would make it unlikely that a contaminant could enter the area slowly enough that it would be considered part of the evolving uncontaminated environment.

Hybrid Detection Systems

The present invention may be used with a set of sensors working in different spectral domains. Each sensor could be detecting data continuously from the same environment. Each data stream can be input to a different prediction model 46. A post processing voting method may be used to correlate the output of these prediction models. For instance, a prediction model 46 for an IR sensor might detect an anomaly at the same time as another prediction model for an acoustic sensor. Thus, a likely event of interest might only be identified if both the IR and the acoustic prediction models indicated a likely event of interest.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

What is claimed is:

1. A method for detecting a likely event of interest, comprising:
providing a prediction model M for a detection system, wherein when each of a plurality of data samples are input to M, said model M outputs a prediction related to a subsequent one of said data samples following said prediction;
first predicting, by M, two consecutive predictions P₁ and P₂ of said predictions, while said detection system does detect a likely event of interest, E₁, such that E₁ is detected using an output by M;
wherein for said two consecutive predictions P₁ and P₂ (a1) through (a3) following hold:
(a1) P₁ is determined by M as a first function of a first multiplicity of said data samples that are provided to M prior to said P₁, wherein for each data sample, DS₁, from said first multiplicity of data samples, said detection system does not detect any likely event of interest, E₁, such that E₁ is detected using an output by M when DS₁ is input to M;
(a2) P₂ is determined by M as a second function of a second multiplicity of said data samples that are provided to M prior to said P₂, wherein for each data sample, DS₂, from said second multiplicity of data samples, said detection system does not detect any likely event of interest, E₂, such that E₂ is detected using an output by M when DS₂ is input to M; and
(a3) said first multiplicity of said data samples and said second multiplicity of said data samples do not differ by any one of said data samples DS received by M between a determination of P₁ and a determination of P₂;
first determining whether a later one of P₁ and P₂ results in detecting an occurrence of a likely event of interest;
second predicting, by M, two consecutive predictions P₃ and P₄ of said predictions while said detection system does not detect a likely event of interest, E₂, such that E₂ is detected using an output by M;
wherein for said two consecutive predictions P₃ and P₄ (b1) through (b3) following hold:
(b1) P₃ is determined by M as a third function of a third multiplicity of said data samples that are provided to M prior to said P₃, wherein for each data sample, DS₃, from said third multiplicity of data samples, said detection system does not detect any likely event of interest, E₃, such that E₃ is detected using an output by M when DS₃ is input to M;
(b2) P₄ is determined by M as a fourth function of a fourth multiplicity of said data samples that are provided to M prior to said P₄, wherein for each data sample, DS₄, from said fourth multiplicity of data samples, said detection system does not detect any likely event of interest, E₄, such that E₄ is detected using an output by M when DS₄ is input to M; and
(b3) said third multiplicity of said data samples is different from said fourth multiplicity of said data samples by one of said data samples DS₀ received by M between a determination of P₃ and a determination of P₄;
second determining whether a later one of P₃ and P₄ results in detecting an occurrence of a likely event of interest;
outputting, in response to a result from at least one of said steps of first and second determining, at least one of:
(c1) first data indicative of no occurrence of a likely event of interest being detected, and
(c2) second data indicative of an occurrence of a likely event of interest being detected.

2. The method of claim 1, wherein said providing step includes training said prediction model M.

3. The method of claim 1, wherein said prediction model M includes an artificial neural network.

4. The method of claim 1, further including a step of receiving said plurality of data samples from at least one sensor for sensing environmental changes.

5. The method of claim 1, wherein said first predicting step includes supplying for each of said predictions P₃ and P₄, one of said data samples as an input to an artificial neural network.

6. The method of claim 5, wherein said artificial neural network includes a plurality of radial basis functions.

7. The method of claim 1, wherein said first determining step includes determining a difference between: (i) said later one of P₃ and P₄, and (ii) said subsequent data sample related to said later one of P₁ and P₂.

8. The method of claim 1, wherein said first determining step includes comparing (a) and (b) following:
(a) a measurement of a discrepancy between (i) and (ii) following: (i) at least one of said P₁ and P₂, and (ii) said subsequent data sample related to said at least one of P₁ and P₂ with
(b) a threshold obtained using a variance that is a function of other measurements, wherein each of said other measurements measures a discrepancy between one of said predictions prior to said at least one of P₁ and P₂, and said subsequent data sample related to said one prediction.

9. The method of claim 1, further including:
determining a first relative prediction error between at least one of P₃ and P₄ and said subsequent data sample related to said at least one of P₃ and P₄; and
determining said variance from a standard deviation of a moving average of a plurality of prior relative prediction errors, wherein each of said prior relative prediction errors is derived from a particular one of said predictions prior to said at least one of P₃ and P₄, and from said subsequent data sample related to said particular prediction.

10. The method of claim 1, wherein said first determining step includes determining whether, there is a series of said predictions, prior to and including P₃ and P₄, of a predetermined length, wherein there are almost consecutive predictions from said series, and each prediction of said almost consecutive predictions is used to obtain a corresponding value that is identified as outside a range that is expected to be indicative of no likely event of interest being detected.

11. The method of claim 10, wherein said determining step includes comparing each of said corresponding values with a corresponding threshold indicative of a boundary between said range that is expected to be indicative of no likely event of interest being detected, and a different range that is expected to be indicative of a likely event of interest.

12. The method of claim 11, wherein said corresponding threshold is a function of a standard deviation of a plurality of measurements, wherein each of said measurements is obtained using at least one difference D between: (i) one of said predictions P_{D} provided by M prior to at least one of P₃ and P₄, and (ii) said related subsequent data sample for P_{D}

13. The method of claim 12, wherein each of said measurements is essentially obtained from a predetermined plurality of said differences D, wherein said predictions P_{D} are not used by said detection system in detecting any likely event of interest.

14. The method of claim 1, wherein said second predicting step includes determining each of P₁ and P₂ without either of said P₁ and P₂ being dependent upon one of said data samples that the other of said P₁ and P₂ is not dependent upon.

15. The method of claim 1, wherein said second predicting step includes outputting, for at least one of said predictions P₁ and P₂, one of:
(a) one of said predictions immediately prior to a detection of said likely event of interest E₂;
(b) one of said data samples immediately prior to a detection of said likely event of interest E₂;
(c) an average of values obtained from some plurality of said predictions immediately prior to a detection of said likely event of interest E₂, wherein each prediction P of said some plurality of predictions is obtained when one or more of: (i) said detection system is-not detecting any likely event of interest, E, wherein E is detected using an output by M, and (ii) P does not result in said detection system detecting any likely event of interest; and
(d) an average of some plurality of said actual data samples immediately prior to a detection of E₂.

16. The method of claim 1, wherein said second determining step includes comparing:
(c) a measurement of a discrepancy between: (i) said later one of P₁ and P₂, and (ii) said subsequent data sample related to said later one of P₁ and P₂ with
(d) a threshold obtained using a variance that is a function of other measurements, wherein each of said other measurements measures a discrepancy between one of said predictions prior to said later one of P₁ and P₂, and said subsequent data sample related to said one prediction.

17. The method of claim 12, wherein said second determining includes determining said variance by computing a standard deviation of said other measurements.

18. The method of claim 1, wherein said outputting step includes providing at least one said first and second data to one or more post processing subsystems for at least one: for further verifying that a detected likely event of interest is an event of interest, wherein said one post processing module, alerting a responsible party, and performing a corrective action.

19. The method of claim 18, wherein said one or more post processing subsystems identify events of interest in said data samples wherein said data samples are obtained from images, sounds, and a chemical analysis.

20. The method of claim 1, further including performing said steps of providing, first predicting first determining, second predicting, second determining, and outputting for each of a plurality of prediction models M, wherein each of said prediction models is trained to detect a likely event of interest substantially independently of every other of said prediction models.

21. A detection system for detecting a likely event of interest, comprising:
a prediction model M, wherein when each data sample of a plurality of data samples, C, are input to M, said model M outputs a prediction related to a subsequent one of said data samples following said prediction;
wherein M predicts predictions P₁, P₂, P₃, and P₄ of said predictions, such that (a1) through (a5) following hold:
(a1) P₁ and P₂ are consecutive predictions obtained while said detection system does detect a likely event of interest, E₁, such that E₁ is detected using an output by M;
(a2) P₃ and P₄ are consecutive predictions, obtained while said detection system is-not detecting any likely event of interest, E₂, such that E₂ is detected using an output by M,;
(a3) for each prediction P of predictions P₁, P₂, P₃, and P₄, P is determined by M as a function of a corresponding multiplicity of said data samples C that are provided to M prior to a determination of P, such that for each data sample, DS, from said corresponding multiplicity of data samples, said detection system does not detect any likely event of interest, E, such that E is detected using an output by M when DS is input to M;
(a4) said corresponding multiplicity of said data samples for P₁ and said corresponding multiplicity of said data samples for P₂ do not differ by any one of said data samples DS used by M between a determination of P₁ and a determination of P₂;
(a5) said corresponding multiplicity of said data samples for P₃ is different from said corresponding multiplicity of said data samples for P₄ by one of said data samples DSo used by M between a determination of P₁ and a determination of P₂;
a prediction engine for receiving said predictions and determining whether a likely event of interest is detected, wherein said prediction engine includes one or more programmatic elements for comparing (c1) and (c2) following:
(b1) a measurement of a discrepancy between (i) and (ii) following: (i) P₁, and (ii) said subsequent data sample related to P₁; and
(b2) a threshold obtained using a variance that is a function of other measurements, wherein each of said other measurements measures a discrepancy between one of said predictions prior to P₁, and said subsequent data sample related to said one prediction.

22. The apparatus of claim 21, wherein said prediction model includes variables whose values adapt with said data samples.

23. The apparatus of claim 21 further including a plurality of prediction models, wherein each prediction model M₀ of said plurality of prediction models has a different corresponding collection C₀ of data samples as input thereto, and wherein said model M₀ outputs a prediction related to a subsequent one of said data samples for C₀ following said prediction, wherein M₀ predicts predictions P_{0,1}, P_{0,2}, P_{0,3}, and P_{0,4} of said predictions, such that (a1) through (a5) hold when P₁, P₂, P₃, and P₄ are replaced with P_{0,1}, P_{0,2}, P_{0,3}, and P_{0,4} respectively, and said data samples C is replaced said collection C₀.:

24. A method for detecting a likely event of interest, comprising:
providing one or more of computational models so that for each of said models M, when M receives a corresponding one or more data samples DS, said model M outputs a prediction P_{M} related to a subsequent data sample DS_{P} of said corresponding one or more data samples;
for each of said models M, and for a corresponding collection C_{M} of a plurality of said predictions P_{M} by M, perform the following steps (A) through (C):
(A) first determining a value V of a first threshold, V being dependent upon, for each P_{M} of C_{M}, a measurement of a variance between: (a1) the P_{M} of C_{M}, and (a2) the subsequent data sample DS_{P} related to P_{M} of (i);
(B) comparing, for a prediction P₀ output by M: (b1) a variance between P₀ and its related subsequent data sample DS₀ with (b2) said first threshold value V;
(C) second determining, using a result from said step of comparing, whether there is a change between: (c1) an instance of a likely event of interest occurring, and (c2) an instance of a likely event of interest not occurring;
wherein for at least one of said models, M₀, there is a prediction P₁ by M₀ that is dependent on one of said data samples, DS, and an immediately previous predication P₂ by M₀ is independent of DS; and wherein there are consecutive predictions P₃ and P₄ by M₀ that do not differ by any one of said data samples DS used by M₀ between a determination of P₁ and a determination of P₂.

25. The method of claim 24, further including, for at least one of said models Mₓ, a step of obtaining said collection C_{M} for Mx mostly from a set of predictions by Mₓ, wherein each prediction P of said set is identified according to an indication that said prediction P is not indicative of an instance of a likely event of interest occurring.

26. The method of claim 25, further including a step of determining said indication by comparing a variance between P and its related subsequent data sample with a value for said first threshold that was determined prior to determining the value V.

27. The method of claim 26, wherein said step of determining includes generating P using different data from data used in generating an immediately previous prediction by M₀.

28. The method of claim 27, wherein between the step of generating P and a step of generating said immediately previous prediction, Mₓ adaptively changes a value of at least one variable that in turn results in difference between P and said immediately previous prediction.

29. The method of claim 24, wherein for at least one of said models Mₓ, said step of first determining includes obtaining a standard deviation of measurements that are dependent upon, for each P_{M} of C_{M} for Mₓ, a difference between: (i) and (ii) of step (A).

30. The method of claim 29, wherein said step of obtaining includes determining said measurements using substantially only predictions by Mₓ that are not identified with a likely event of interest.

31. The method of claim 24, wherein said first threshold one of: a threshold for determining when a likely event of interest is detected, a threshold for determining when a likely event of interest terminates.

32. The method of claim 24, further including a step of generating, by at least one of said models, a prediction by activating an artificial neural network

33. The method of claim 24, further including a step of generating, by at least one of said models, a prediction by activating one of: a Bayesian forecasting process, a regression process, and a Box-Jenkins forecasting process.

34. The method of claim 24, further including a step of adapting a signal receiver to receive a desired signal in an environment of changing signal conditions causing interference with the desired signal, wherein at least one of said models generates predictions that are indicative of said desired signal.

35. A method for determining a likely event of interest, comprising:
supplying, to each of one or more adaptive models, a corresponding series of data samples,
for each of said adaptive models M, and for each data sample ds_{A} of said corresponding series S_{M}, perform the following steps (a) and (b):
(a) generating a prediction, by M, when ds_{A} is input to M, wherein said prediction includes a value v which is expected to correspond to a data sample ds_{B} of S_{M} wherein ds_{B} is subsequent to ds_{A} in S_{M};
(b) inputting information to M obtained from one or more errors in said predictions by M in order to reduce at least one of: (i) subsequent instances of said prediction errors by M, and (ii) a variance in the subsequent instances of said prediction errors,
for at least one of said adaptive models, M₀, said step of inputting is performed substantially only when corresponding series is not indicative of a likely event of interest, and for said M₀, performing the following steps:
(c) obtaining a measurement V of variance of a plurality of prediction errors between said values v and their corresponding values v_{B} for M₀;
(d) determining a further instance of one of said prediction errors for M₀;
(e) determining a relationship between said variance V and said further instance for determining whether a likely event of interest has likely occurred; and
(f) when the likely event of interest is detected, M₀ determines at least two consecutive predictions during said likely event of interest, wherein said predictions are only dependent on the predictions errors of M₀ obtained prior to an earlier of said consecutive prediction errors.
